(19) United States
(12) Patent Application Publication
(10) Pub. No.: US 2009/0228830 A1
(43) Pub. Date: Sep. 10, 2009

(54) System and Method for Data Analysis and Presentation

(76) Inventors: J.C. Herz, Alexandria, VA (US); Jonathan Cousins, New York, NY (US); Greg Elin, Buffalo Grove, IL (US); John M. Scott, III, Alexandria, VA (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/388,868

(22) Filed: Feb. 19, 2009

Related U.S. Application Data
(60) Provisional application No. 61/030,058, filed on Feb. 20, 2008.

(51) Int. Cl. G06F 17/30; G06F 3/048

(52) U.S. Cl. 715/808; 715/810; 715/854; 707/E17.048; 707/5; 707/E17.014

(57) ABSTRACT

Disclosed embodiments relate to the graphical display of relationships between entities of interest, and specifically between entities in a network of relationships. In such embodiments, multiple icons on an axis between two entities are used to indicate that the entities have multiple relationships. Disclosed embodiments also provide methods of navigating, filtering, and manipulating the display of networked relationships, according to the numerical distribution of relationships and specific combinations of relationships. Disclosed embodiments provide methods of manipulating the display of networked relationships so that relationships between entities can be visually collapsed, and entities can be treated as links between other entities for the purposes of filtering and display.

### CROSS-REFERENCE TO RELATED APPLICATIONS

This application claims priority to U.S. Provisional Application Ser. No. 61/030,058, entitled “System and Method for Data Analysis and Presentation,” filed Feb. 20, 2008, which is incorporated herein by reference in its entirety.

### COPYRIGHT NOTICE

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

The disclosed system and method relate generally to the field of data processing and more particularly, but not by way of limitation, to processing and presenting data about relationships between entities of interest (such as people, organizations, events, projects or publications) and for navigating, filtering and querying a visual display of more detailed underlying data about related entities.

Systems and methods are generally known for displaying relationships between entities of interest by processing underlying data about those relationships. Known systems and methods for displaying relationship data have many disadvantages, however, particularly when the underlying data set is large, or contains highly clustered or interconnected relationships between entities. For example, if a set of relationship data contains many entities with large number of connections to other “super-connected” entities, the display result is typically a huge number of dots or icons connected by an even larger number of lines. This “birds' nest” image of cross-linked nodes is not particularly useful for analytic purposes. Furthermore, as more data is added, the analytic usefulness of the interface degrades amidst the clutter of additional nodes and an overwhelming proliferation of new links.

Previous technologies to display network graphs create visual clutter by rendering large numbers of lines between highly connected nodes. Using these technologies, even the ability to filter on the strength of connections between individuals does not allow users to ask important questions about the relative importance of groups of nodes to each other when their relationships are weak, nor do they allow the user to easily filter and search for particular combinations of relationships to specific entities. Two entities might have 6 or 12 or 40 separate relationships between them. But if an end-user is particularly interested the combination of three specific relationships that defines a particular group of related entities, it is difficult if not impossible, using current tools, to navigate or filter a graph according to where that specific combination of relationships occurs.

In one respect, what is needed is a more robust set of techniques for manipulating, querying, filtering and displaying data about relationships, in a way that allows an end-user to understand a network of relationships according to how specific relationships combine, and the patterns of those combined relationships within a network. In another respect, what is needed is a more sophisticated way of qualifying and quantifying relationships between entities, so that filters may be more powerfully combined to yield salient analytical results.

In another respect, what is needed is a more robust way of transforming data about relationships, so that the user may perform operations on the data, in addition to merely filtering and navigating it.

### SUMMARY OF THE INVENTION

Disclosed embodiments relate to the graphical display of relationships between entities of interest, and specifically between entities in a network of relationships. In such embodiments, multiple icons on an axis between two entities are used to indicate that the entities have multiple relationships.

Networked relationships may be displayed and navigated according to the number, frequency and combination of relationships between entities, including: viewing combinations of relationships between entities in ranked order, according to the frequency of those relationships in the data; selecting and de-selecting the display of single or multiple relationships; and re-configuring a network graph based on the presence of particular combinations of relationships between entities.

Networked relationships may be displayed according to the numerical distribution of relationships between entities, including filtering and combining filters on the numerical distribution of relationships between entities. These filters operate on a number of parameters in the metadata associated with each entity and its relationships, including the connectivity of a entity (its total number of relationships to other entities), affinity (the total number of relationships between any two given entities), the date of a relationship, and a scalar weighting associated with a relationship (e.g. the strength of the relationship, or a confidence rating on the information).

Data about relationships may be displayed and navigated in a summary view of the data, including: selecting and deselecting relationships to see an overview of the occurrence of those relationships in a search result; and navigating between search results in a detailed view by activating controls in a summary view of relationship distributions.

Data may be manipulated, such that entities can be transformed into relationships between other entities, and treated as links for the purpose of filtering and display.

Several exemplary embodiments shown in the drawings are described below. These and other embodiments are more fully described in the Detailed Description section. It is to be understood, however, that there is no intention to limit the scope of protection by the forms described in this Summary of the Invention or in the Detailed Description. One skilled in the art can recognize that there are numerous modifications, equivalents and alternative constructions that fall within the scope and spirit of the protection as expressed in the claims.

### BRIEF DESCRIPTION OF THE DRAWINGS

Exemplary embodiments are described with reference to the following drawings.

FIG. 1 is an illustration of a data presentation, which illustrates the first step in a user-generated search.

FIG. 2 illustrates a data presentation displaying a search term displayed before related entities are presented.

FIG. 3 illustrates a data presentation showing the display after a user launches a search and the data has loaded.

FIG. 4 is a close-up view of FIG. 3, with the arrows pointing to icons representative of multiple relationships between entities.

FIG. 5 illustrates a list of a node's relationships to other entities in the data.

FIG. 6 illustrates displaying a list of relationships after activating the control in FIG. 5.

FIG. 7 illustrates displaying a connection term, indicating the nature of a relationship, as the user mouses over a relationship bead.

FIG. 8 illustrates locking the color change of beads with a similar connection term of a clicked bead.

FIG. 9 illustrates a multi-affinity relationship sequenced according to the frequency count in the data.

FIG. 10 illustrates multiple locked beads on a display.

FIG. 11 illustrates multiple locked beads on a display.

FIG. 12 illustrates relationships locked in the display.

FIG. 13 illustrates displaying a user-designated combination of relationships.

FIG. 14 illustrates how a user can click on an icon to activate the information overview mode of display.

FIG. 15 illustrates how the user has launched the information overview mode of display and locked one bead.

FIG. 16 illustrates how the user may lock multiple beads to see multiple relationships in the airplane view.

FIG. 17 illustrates how the user may navigate through search results in the airplane view by clicking on any of the icons associated with a node.

FIG. 18 illustrates how the user can access data filtering capability by activating the meta filter control.

FIG. 19 illustrates how the user may filter by affinity, using the meta filter control.

FIG. 20 the meta filter control for affinity set such that all nodes with only one relationship to the search term have vanished from the display.

FIG. 21 illustrates nodes in a search result reappearing in the display after restoring the meta filter control for affinity.

FIG. 22 illustrates how the user may also filter by connectivity.

FIG. 23 illustrates using the meta filter control for connectivity to adjust the maximum affinity threshold.

FIG. 24 illustrates how the user may eliminate a significant number of nodes from the display.

FIG. 25 illustrates the display in FIG. 24 after the results have been condensed.

FIG. 26 illustrates how the user may activate a meta filter control to filter on the strength of relationships in the data.

FIG. 27 illustrates how the user may activate meta filter controls to constrain the display of search results by date.

FIG. 28 shows search results filtered according to a date range.

FIG. 29 is an abstract diagram of the process whereby a node in the data is transformed into a connecting term.

FIG. 30 illustrates how the user may collapse nodes by activating a control proximate to the node.

FIG. 31 illustrates a search result transformed by a collapse-node operation.

FIG. 32 illustrates the display of a two-box text label describing a collapsed relationship

FIG. 33 illustrates relationships of affinity and connectivity among various entities.

FIG. 34 illustrates relationships of strength and connectivity among various entities.

### DETAILED DESCRIPTION

This section discloses exemplary embodiments related to the processing and display of data about relationships between entities of interest. Certain portions of this description explain embodiments in the narrative context of a business use case. In this business use case, a sales analyst seeks a clearer understanding of his company's customers, and the relationships between the company, its products, and its customers through a series of sales transactions. This narrative description is used to make disclosures and explanation and the Figures in this document more concrete and understandable. Because the disclosed embodiments are designed for use across industries and endeavors, the analytic task used here for narrative purposes in no way limits the scope of protection, or the claims made herein, to the particular use case or industry context used for purposes of explanation in this document.

Data may be stored in a triple format that includes three terms: two subjects, herein referred to as nodes, and one linking term describing their relationship. For example, a sales transaction between Acme Corporation and Spacely Sprockets might be stored as the three terms, “Acme Corporation,” “Sale—Product X” and “Spacely Sprockets.” We refer to this series of three terms as a “triple.” We refer to the end points of each triple as “subjects” or “nodes”, and to the linking term as a “connection.”

When a user launches a search for “Acme Corporation,” he sees the triples containing the term “Acme Corporation.” These triples may be displayed as text in a list, or as a graphical array of nodes connected to “Acme Corporation” through their linking relationships to Acme.

Additional data about the relationships described in these triples may be stored as metadata associated with each triple. Each relationship is automatically associated with the user who generated the information, and with permissions data specifying which users are allowed to view that particular triple. In addition, users may associate key words, strength ratings, dates, source information, notes, web links, and other metadata with each triple. A triple may be designated for inclusion in more than one collection of triples, with each collection subject to a different permissions configuration, i.e. different people have access to different collections. Users may also associate sections of free-form text (notes) with any triple or group of triples, and these notes are associated with each triple as metadata. These metadata are stored in the system, and may be used to search and filter information, and to modify its display.

The visualization component of the application communicates with a back-end database through data management software that receives requests (i.e. searches, navigation, sorting and filtering) generated by the user's interaction with the interface. Upon receipt of these requests, the data management software queries the database, receives the query results from the database, and returns the resulting triples and their metadata to the visualization application. Data returned to the visualization application includes:

1) The set of triples that constitutes a complete response to the query

2) Affinity counts for each node, in relation to the search result, i.e. how many relationships are between each node and the search node. The affinity counts are used to determine the sequence of search results, and to alter the display of results as the user filters on affinity.

3) The connectivity counts of each node. These counts are used to alter the display of results as the user filters on connectivity

4) The strength, date, and source of each triple, its contributor, and any tags and metadata associated with it. These results are used to alter the display as the user narrows a search using metadata, or filters on strength, date, source, contributor, or user-generated tags or notes.

5) The frequency count of each relationship term that occurs in the search result. This count is used to sequence icons on the axes between nodes.

Once the image is rendered, the user can interact with the application to alter the image and/or explore it in detail. In some instances, the application might communicate with data management components of the system, but in a way that is not the direct result of a user request. For example, the visualization application might return to the data management system to see if there have been any updates to the data source in the time since the data was originally requested.

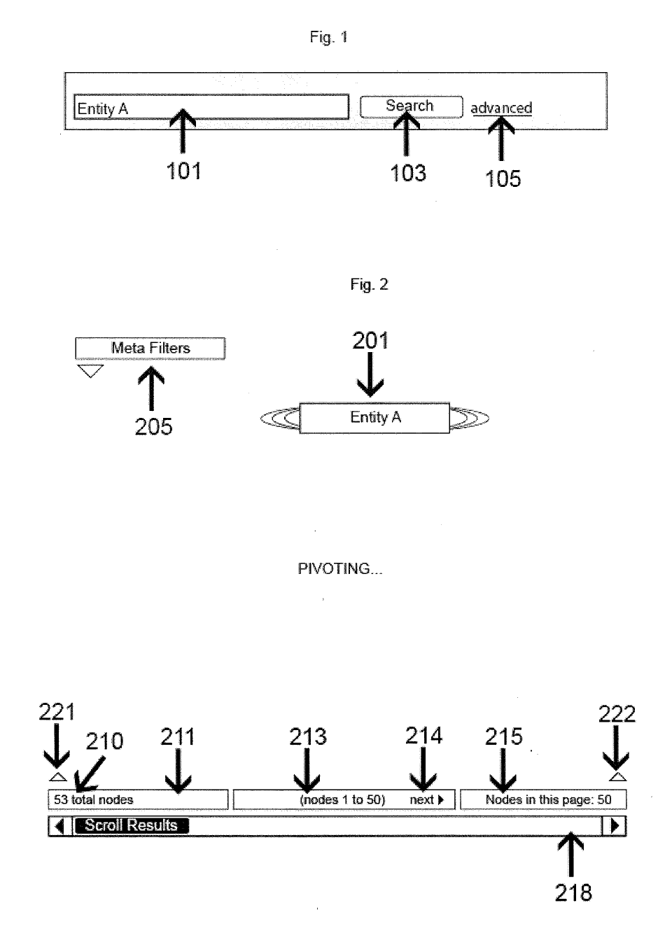

FIG. 1 illustrates a data presentation for a first step in a user-generated search. In this illustration, the user launches a search for “Entity A,” which is his product division. For example, the user can enter the search criteria (e.g., “Entity A”) in search term box 101, and launch the search by clicking on or activating button 103. In some embodiments, control 105 can be activated (e.g., by clicking on the control) to access additional or advanced search features. Advanced search features can include, for example, specifying one or more logical connectors such as AND, OR, XOR,

In FIG. 2, search term, “Entity A,” is displayed as icon 201 before related entities are presented. The width of the ellipse or number of concentric rings around the text of the search term (i.e. “Entity A”) indicates the number of relationships between Entity A and other terms in the database. This visual connectivity indicator correlates with the number of triples containing the term “Entity A” at either end of the triple. This iconography provides a visual indicator of a node's connectivity—a node with ten connections is displayed differently than a node with fifty or 400 connections. This graphic differentiation allows users to visually distinguish between sparsely connected nodes and super-connected hubs without actually having to see all of the connections displayed. Typically, rendering all of a node's connections in order to display its level of connectivity creates visual clutter that overwhelms the user and makes the resulting image less useful for analytical purposes. Disclosed techniques prevent this kind of overload.

In some embodiments, filter control 205 is also displayed. As will be discussed in further detail below, filter control 205 can be activated by a user to filter results of a search. Additionally, in some embodiments, a status bar 210 can be displayed to present status information about the results of a search. For example, status bar 210 can include quantity section 211 that displays a total number of nodes resulting from a search. Node information section 213 that displays the rank of the currently selected or in focus node. In some embodiments, status bar 210 can include navigation controls such as navigation control 214 for advancing to another node. In some embodiments, status bar 210 can include other navigation controls such as a previous node control, or a control to skip forward or backward multiple nodes. Page information section 215 can display information about the current page or view of the results of a search such as, for example, the number of nodes on the current page.

In some embodiments, a scroll control such as scroll control 218 can be included for scrolling horizontally, vertically, or some combination thereof. In some embodiments, one or more prioritization controls such as prioritization control 221 can be activated by a user to prioritize the display of results of a search. In some embodiments, information overview control 222 can be selected to display or activate an information overview mode.

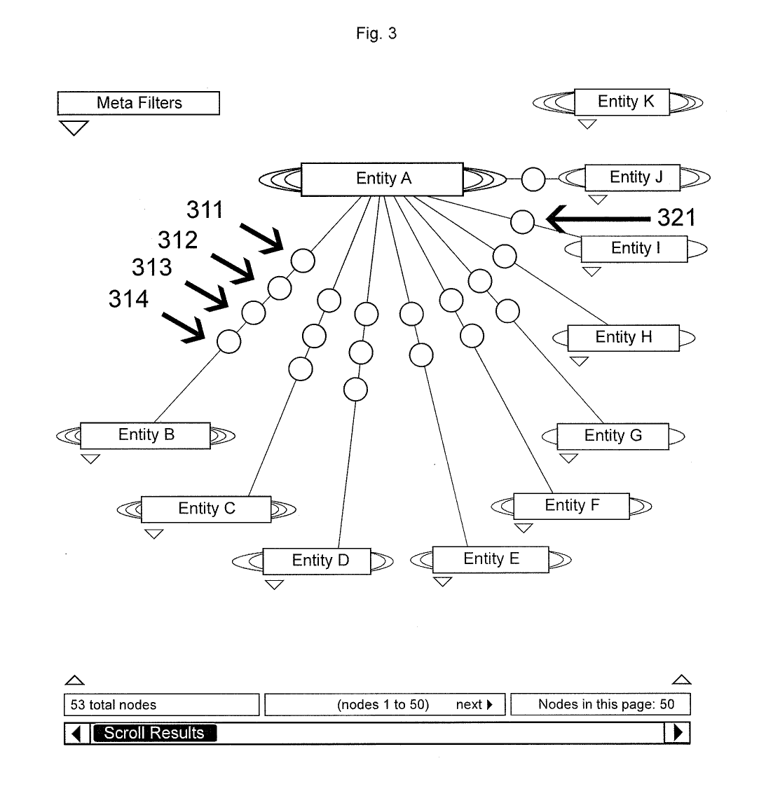

FIG. 3 illustrates the display after the user has launched a search and the data has loaded (i.e. what the display looks like shortly after FIG. 2). The user sees several entities (in this case, Entities B, C, D, E, F, G, H, I, and J) connected to Entity A. In the sales-analyst scenario, these might be companies to whom his division, Entity A, has sold different products. In this scenario, the relationships in the system are instantiated as triples in the following format:

←EntityA˜Product˜EntityX

Where each triple is a sales transaction. The first term is the supplier. The second term (the linking connection term) is the name of the product sold, and the third term is the customer. The triple “Entity A˜Product3˜EntityB” indicates that Entity A sold Product3 to EntityB. Metadata associated with this triple may include the date of the transaction, as well as the dollar value of the transaction.

The visual connectivity iconography in FIG. 3 indicates that Entity B has many connections (in this scenario, many customers of its own) represented by icons 311-314, whereas Entity I has relatively few customers represented by icon 321.

We refer to the method of data representation in FIG. 3. as a “necklace”, because the terms that connect to the search term, “Entity A,” are arrayed in a rotary sequence around the search term. In order to view terms that are not initially visible, the user can reposition the “Scroll Results” control at the bottom of the display, along a horizontal axis. Shifting this control to the right rotates the entire sequence of nodes clockwise, so that the left-most connecting node, “Entity B,” moves up and vanishes, while other entities subsequent to “Entity J” become visible above “Entity J” and scroll down and around, clockwise. The navigation is akin to moving beads around a string. In FIG. 3, “Entity K” is visible just above and to the right of “Entity J.” As the user scrolls the display, “Entity K” will expand to full size and move clockwise in relation to “Entity A.”

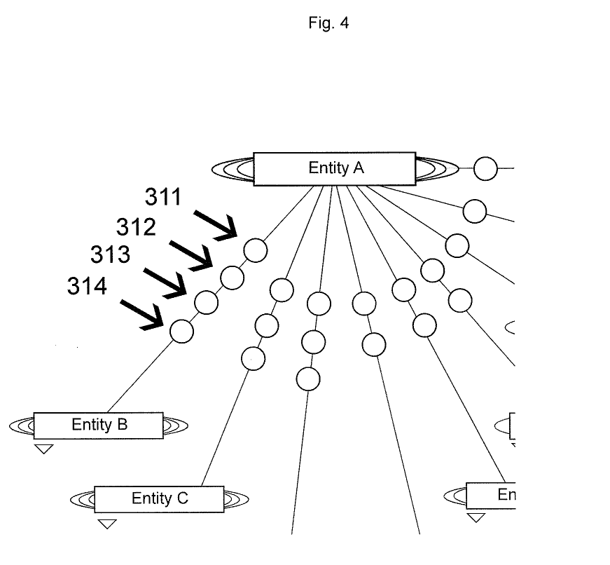

FIG. 4 is a close-up view of FIG. 3, with arrows pointing to four icons 311-314 on the line between “Entity A” and “Entity B.” Multiple relationships between entities are represented as multiple icons displayed entities. We refer to these icons as “beads,” in keeping with the over-arching visual metaphor of the software application. In this image, there are four beads on the line between “Entity A” and “Entity B,” each representing a different relationship or instance of a relationship. In the sales scenario, these might be four separate sales transactions between “Entity A” and “Entity B.”

FIG. 3 and FIG. 4 also illustrate a method of information filtering and navigation. When the user launches a search, the default for information presentation is to display entities in ranked order, according to affinity, which we define as the number of relationships between two entities. According to this method, the results of the search in FIG. 1 are ranked and displayed from highest to lowest affinity. In FIG. 3, “Entity B” is ranked first because it has four relationships to “Entity A.” “Entity B” and “Entity C” are next in the sequence, with three relationships each to “Entity A,” followed by Entities E, F, and G, which each have two relationships to “Entity A.”Next in the sequence are the other connecting nodes, which each have one relationship to “Entity A.”

In the sales scenario, the user sees customers displayed in ranked order, according to the number of sales transactions between those customers and his division, “Entity A.” In this scenario, high-frequency customers show up first, and are displayed in order of decreasing sales frequency. In an alternative scenario, a user might see business partners displayed according to the number of joint projects or co-investments between companies. In each scenario, the default display foregrounds salient connections by displaying high-affinity nodes (those with multiple relationships to the search term) before low-affinity nodes in the sequence of display.

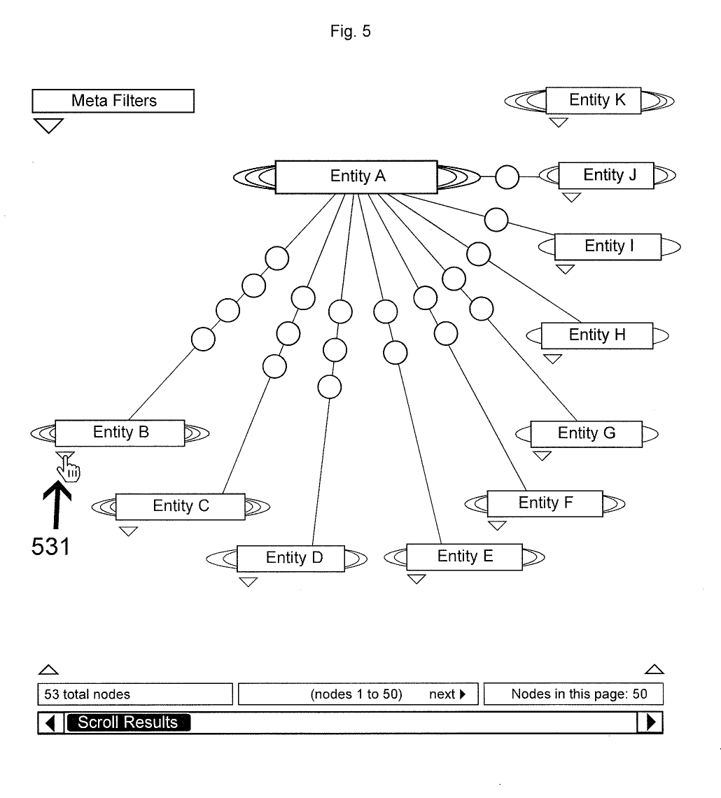

FIG. 5 is an illustration of a data presentation and an interface control. The user may activate a control, illustrated here by arrow icon 531 beneath the node labeled “Entity B”, to view a list of that node's relationships to other entities in the data. In some embodiments, each node includes such a control. Clicking on the icon launches a pop-down list of the node's relationships. Clicking on the arrow again de-activates the list display, causing the list to disappear.

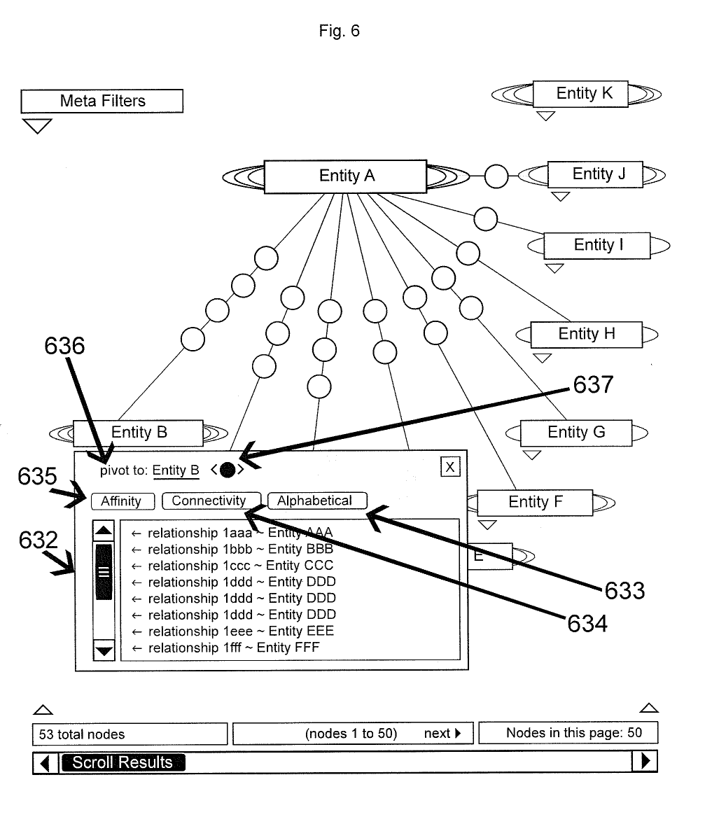

FIG. 6 illustrates data presentation display 632 after the user has activated the control in FIG. 5. The user sees a list of relationships associated with “Entity B”. At the top of the list is link 636, “Pivot to Entity B,” that allows the user to launch a new search on the term “Entity B” by clicking on that term in the drop-down box. We refer to this list of second-degree connections to the search term (i.e. the terms that are connected to “Entity A” through an intermediary node, “Entity B”), as a “peek-ahead list” and to the first-degree node, “Entity B,” as the “pivot term.” Each peek-ahead-list is the result of a search query for the pivot term, launched by the user's activation of the control that opens the peek-ahead list.

The peek-ahead list displays “Entity B's” relationships, i.e. the triples containing “Entity B.” “Entity B” is an implicit term in each row of the list. The two terms displayed in each row of the peek-ahead list are the other two terms, a subject and a connection term, in each triple containing “Entity B.” An arrow indicates the directionality of that relationship. The user may launch a new search on any subject in the peek-ahead list by clicking on the text name of that subject. The user may scroll down the list to see the complete list of relationships to “Entity B.”

The user may also sort and re-order to display the peek-ahead list according to different criteria. FIG. 6 illustrates three ways users can sort and display relationships in the data: by affinity 635, by connectivity 634, or alphabetically 633. In FIG. 6, items in the peek-ahead list are displayed alphabetically. In some embodiments, a user can also select collapse control 637 to display, for example, the relationships of Entity B as related to Entity A via Entity B.

The user may click on the “Affinity” label in the peek-ahead list to see the relationships in that list displayed in order of affinity. This ranking is analogous to the default ranking in the necklace. Sorted by affinity, subjects with the highest number of relationships to the pivot term are displayed at the top of the list. Subjects with fewer relationships to the pivot term are displayed lower down the list. For instance:

←connectionA˜term1

←connectionB˜term1

←connectionC˜term1

←connectionD˜term2

←connectionE˜term2

←connectionF˜term3

←connectionG˜term4

←connectionH˜term5

Term1 has three connections to the pivot term (A, B, and C). Term2 has two connections, and the other terms each have one connection. Therefore, Term1 and its connections are displayed first, then Term2 and its connections, then the other terms and their connections.

Relationships in the peek-ahead list may also be sorted by connectivity. We define a term's connectivity as the number of triples containing a given term, i.e. the total number of relationships that term has to other terms in the data. For instance, if the connectivity counts for the terms above are as follows:

←term1 has 25 relationships to other terms in the data (25 triples contain term1)

←term2 has 14 relationships to other terms

←term3 has 400 relationships to other terms

←term4 has 2 relationships to other terms

←term5 has 150 relationships to other terms

Sorted by connectivity, the peek-ahead list would be displayed as follows:

←connectionF˜term3

←connectionH˜term5

←connectionA˜term1

←connectionB˜term 1

←connectionC˜term1

←connectionD˜term2

←connectionE˜term2

←connectionG˜term4

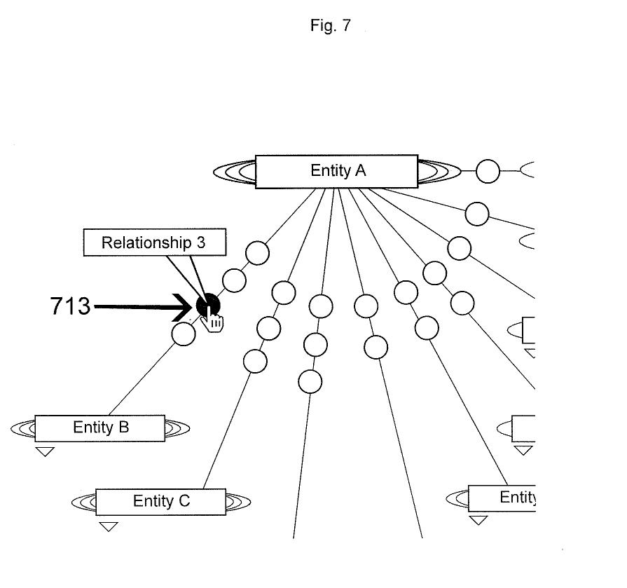

FIG. 7 illustrates the data presentation as the user mouses over icon (also referred to herein as a relationship bead or bead) 713. That bead becomes more visually prominent (in this figure, the icon changes from a pale color to a darker shade), and the connection term is displayed, indicating the nature of the relationship. When the user mouses over one bead, all the beads representing the same connection term change appearance, regardless of where those beads appear in the display. This method of data presentation allows the user to visually identify patterns as an investigation of one relationship highlights all instances of that relationship in the search results.

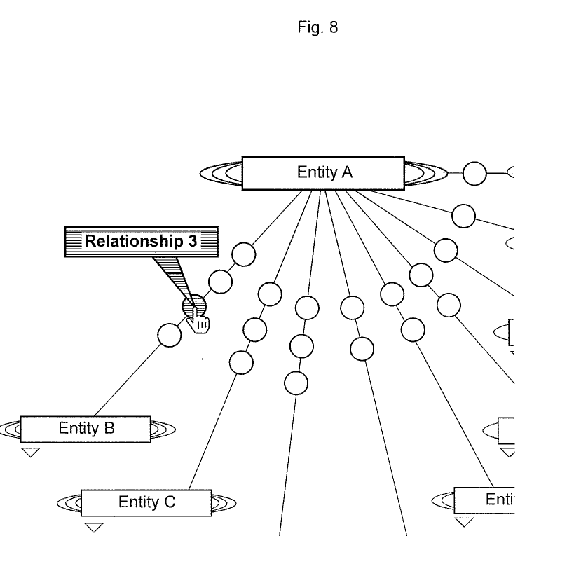

FIG. 8 illustrates the data presentation as the user mouses over a bead. It changes its appearance (as well as the appearance of matching beads in the display), but this change reverts to the original appearance when the user's cursor no longer points to the bead. By clicking on (vs. mousing over) a bead, the user “locks” the bead's change of appearance. In this illustration, locked beads change from a neutral to a bright, highly differentiated color. Matching beads (indicating the same connection term on one or more nodes) change to the same color as the original locked bead. This shift in appearance persists as the user navigates search results. If the user clicks again on the original bead (or a matching bead elsewhere in the results), all beads indicating the same connection term revert to their original color. If the user clicks on a different bead (a different connection term), the second bead turns a different color from the first, and persists until that second connection term is unlocked.

The user may lock and unlock any number of beads in the display. This method of data presentation allows the user to activate and de-activate the visual display of patterns in the data. Specifically, the user may lock particular combinations of relationships to see where those patterns co-occur.

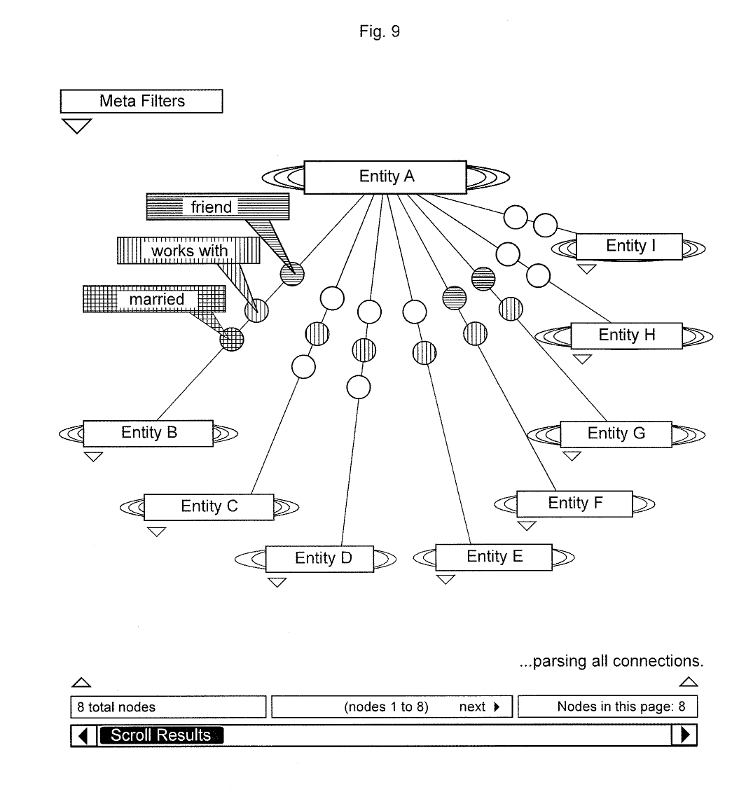

Depending on user setting preferences, the beads in a multi-affinity relationships (sets of more than one relationship between two entities) are sequenced according to their frequency count in the data. In FIG. 9, there are three relationships, “married,” “works with” and “friend.” In the data, there are 5 occurrences of the connection term “married,” 100 occurrences of the connection term “works with,” and 200 occurrences of the connection term “friends.” In the display, the “married” bead is displayed closest to the pivot term, because it is the least common relationship in the data. “Works with” is displayed further away from the pivot term than “married,” because “works with” is a more common relationship in the data than “married.” The “friends” bead is displayed closest to the search term, because it is the most common relationship in the data.

Displaying relationships in order of their frequency in the data allows the user to interpret sets of relationships between entities according to how rare or common each relationship is. Because a rare relationship between entities is often more salient than a common relationship, i.e. “married” is a more rare, and a more salient relationship than “works for” or “friends.” If you're analyzing relationships between people, and there are a lot of relationships between them, “married” is the one you probably want to see displayed most prominently. If an analyst is looking at company affiliations, a relationship between two companies through a two-party joint venture is more salient than a relationship between those companies through an industry consortium that has 400 members.

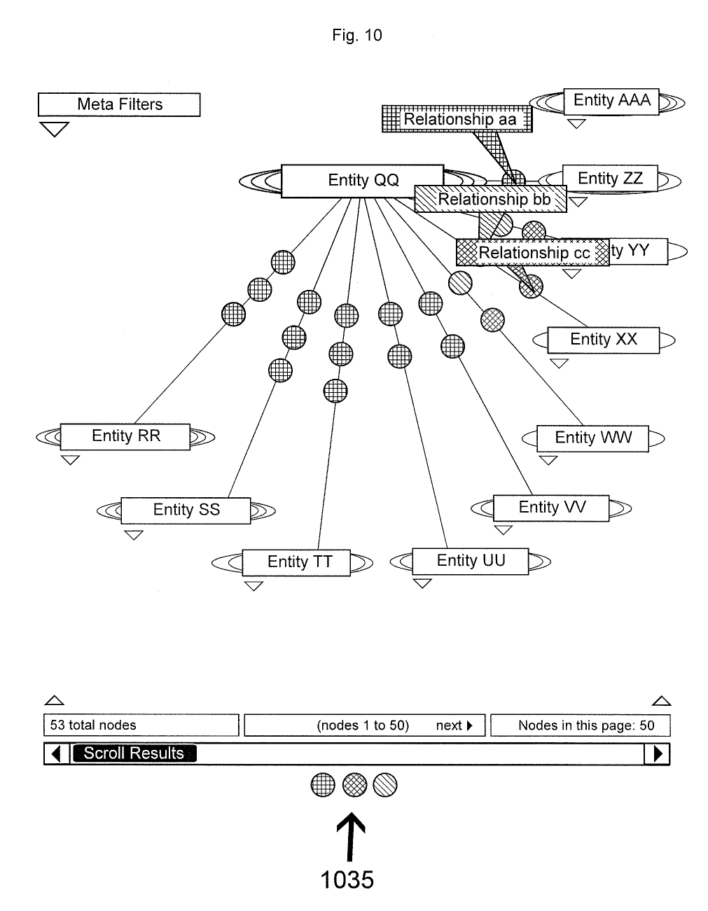

In FIG. 10, the search term is Entity QQ, and the user has locked three different beads that correspond to relationship aa, relationship bb, and relationship cc. In the sales scenario, Entity QQ is a division of the company, and the analyst is looking at sales of the that division's products, “aa,” “bb,” and “cc” to customers RR, SS, TT, UU, VV, WW, XX, YY, and ZZ. In this image, the analyst sees multiple sales of product “aa” from division QQ to customers RR, SS, TT, UU, VV, and ZZ. The analyst also sees that customers WW, XX, and YY have each bought both product “bb” and product “cc.” He can see by the number of transactions that RR, SS, and TT are the biggest customers for “aa,” but that ZZ doesn't buy as much of it.

As the analyst scrolls through the necklace by moving the “Scroll Results” bar horizontally, any “aa,” “bb,” or “cc” beads in the display will be persistently highlighted and color coded. In some embodiments, locked beads are displayed in locked bead notification area 1035. By locking and unlocking different beads, the analyst can see patterns of product sales, and how certain products are more frequently purchased in combination. For instance, he sees a combination of products “bb” and “cc” bought by several customers, and may scroll through the necklace to see whether that purchasing pattern occurs elsewhere in the data.

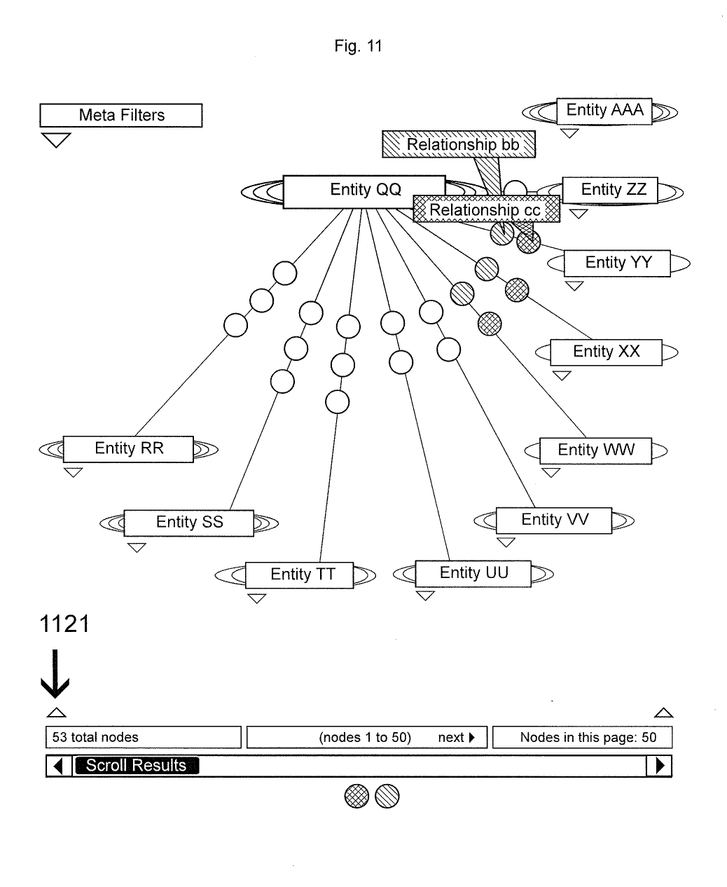

In FIG. 11, the user has unlocked the “aa” bead, and beads “bb” and “cc” remain locked, highlighting the fact that these products are bought in combination by customers WW, XX, and YY. Prioritization control 1121 can be activated to display prioritization controls.

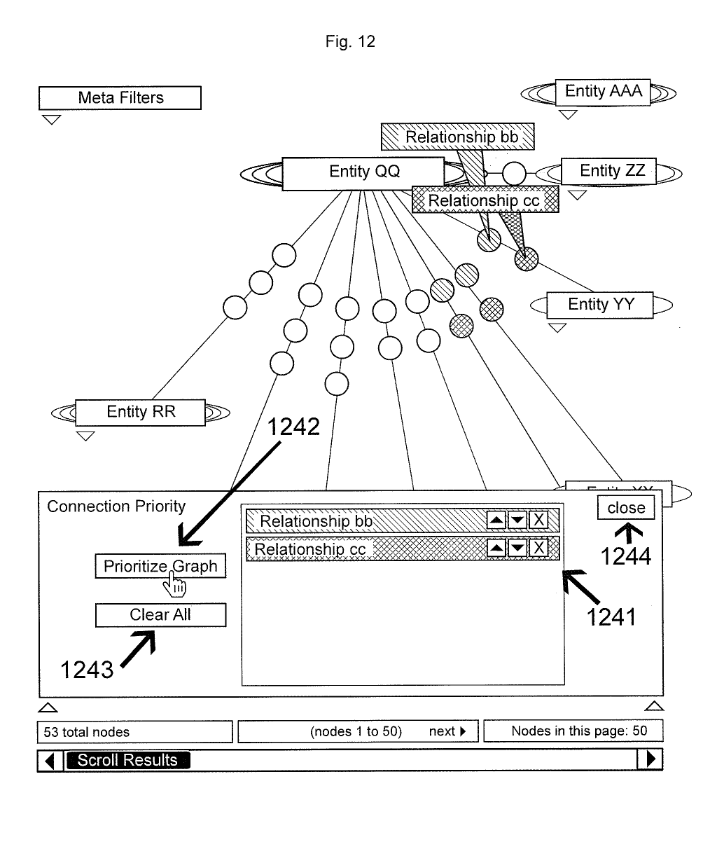

FIG. 12 illustrates a scenario in which the user is interested in the customer base for products “bb” and “cc,” and if other customers have bought both. The user clicks on the up-facing arrow icon at the right above the horizontal scroll bar (as illustrated in by prioritization control 1121 FIG. 11), and activates a prioritization interface, shown in FIG. 12. This interface displays the relationships that the user has locked in the display. The user may add additional relationships to prioritization list 1241 by locking additional beads in the display. Relationships can be removed from the list by, for example, clicking on “Clear All” button (or control) 1243. When the user activates the prioritization function, in this case by clicking on “Prioritize Graph” button 1242, the data is sorted and re-displayed to prioritize the combination of relationships selected by the user. The user can close the prioritization interface by clicking on or activating “close” control 1244.

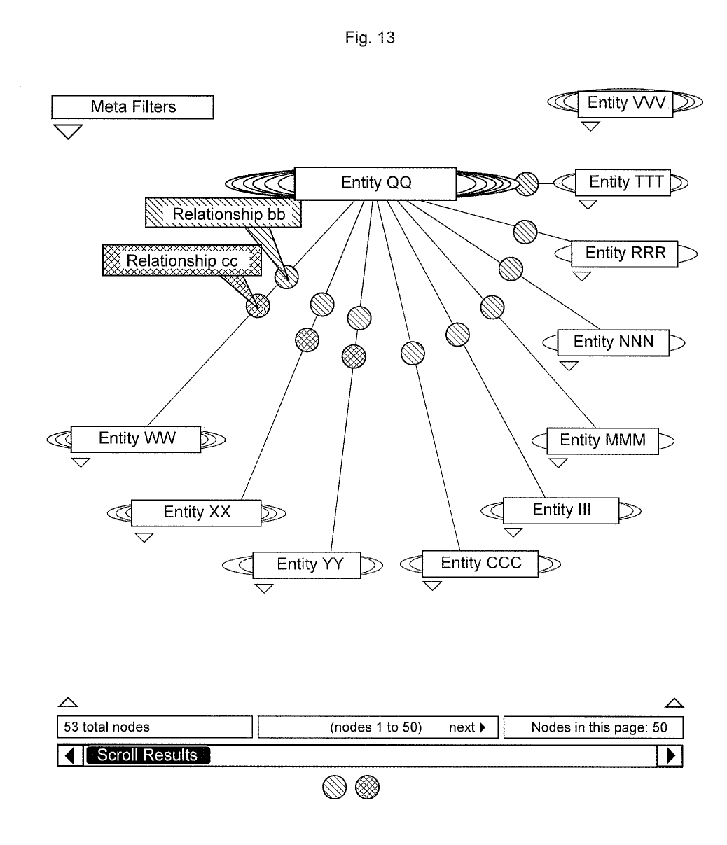

FIG. 13 illustrates how, after the user activates the prioritization function, relationships to the search term, “Entity QQ,” are not displayed in order of affinity to QQ. Instead, all nodes connected to QQ by the user-designated combination of relationships (in this case, “bb” and “cc”) are displayed first, followed by all nodes connected by either “bb” or “cc,” followed by nodes with neither “bb” nor “cc” relationships to QQ. In the sales scenario, the analyst sees all customers who have bought both “bb” and “cc” first in the sequence, followed by customers who have bought either “bb” or “cc” and then customers who are connected to QQ but have bought neither “bb” nor “cc.”

This reprioritization method may be employed for any arbitrary combination of relationships. If the analyst has sales data on 20 different products, he may run a prioritization search that displays the customers who have bought any combination of those 20 products. The ranked results may change significantly, depending on which combinations of products are prioritized. In this fashion, the analyst may visually discern patterns of product sales that define customer profiles or clusters. For example, customers who buy a combination of four specific products (1, 2, 3, 4) don't buy any other products unless they've also bought products 5 and 6. By running a prioritization search on the combination of products 5 and 6, the analyst gains insight about the customer base for 5 and 6, and, by exploring the secondary connections in that data, might determine what about the combination of 5 and 6 facilitates follow-on sales (i.e. 5 and 6 are only sold by a particular salesman, who is a great door-opener).

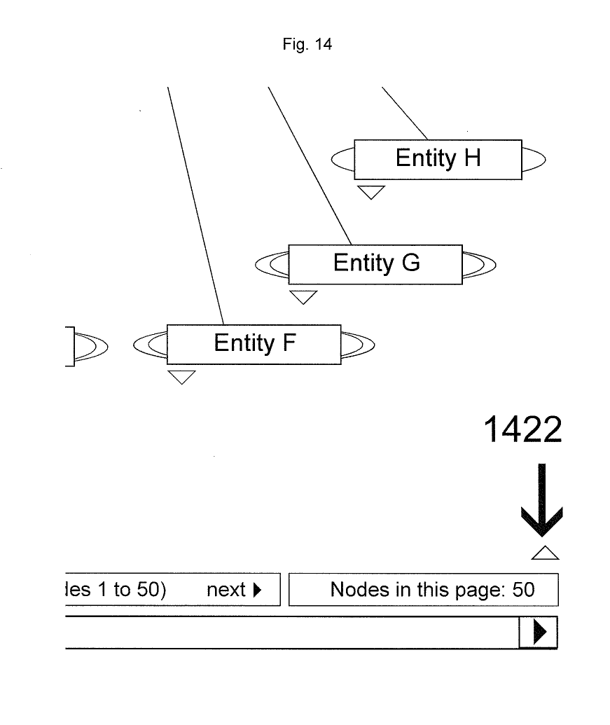

FIG. 14 illustrates how a user can click on icon 1422 to activate the information overview mode of display.

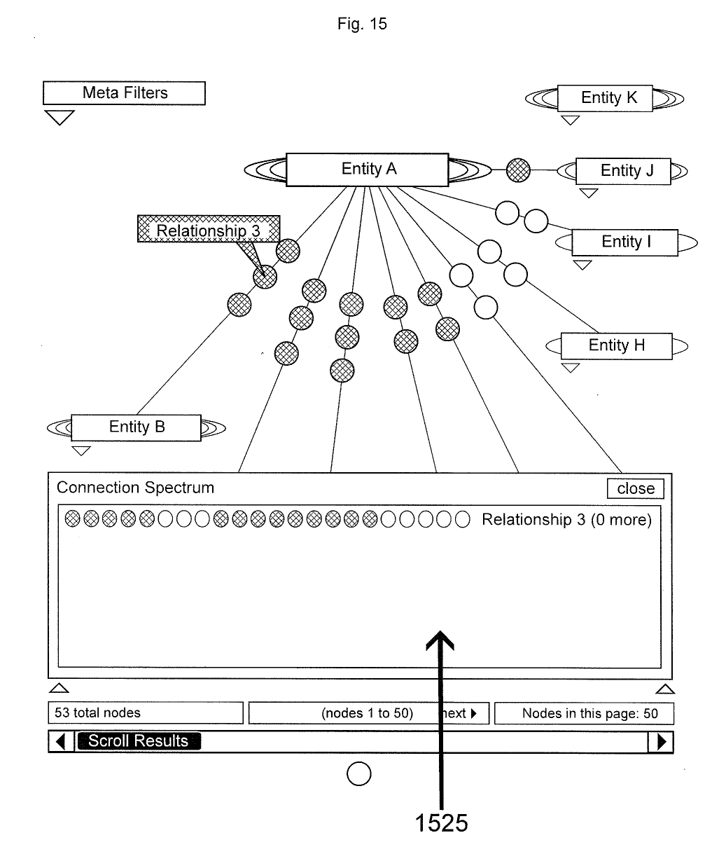

FIG. 15 illustrates how the user has launched the information overview mode of display and locked one bead, “relationship 3.” In this mode, the user sees the occurrence of “relationship 3” in the first fifty nodes on the necklace in display 1525. For searches with more than fifty nodes in the results, the user can scroll to the next fifty terms in the overview mode by clicking on the “next” arrow above the horizontal scroll bar. In this illustration, the user sees the occurrence of “relationship 3” in the first fifty nodes on the necklace. Colored icons (in this case, ovals) indicate that a node in the sequence of 50 nodes has “relationship 3” to the search term, “Entity A.” Ovals that are not highlighted indicate that an entity does not have “relationship 3” to the search term. So in the overview, the user sees the distribution of a given relationship across a large sequence of nodes. We refer to this information overview mode as the “airplane view” because it resembles the seating chart of an airplane.

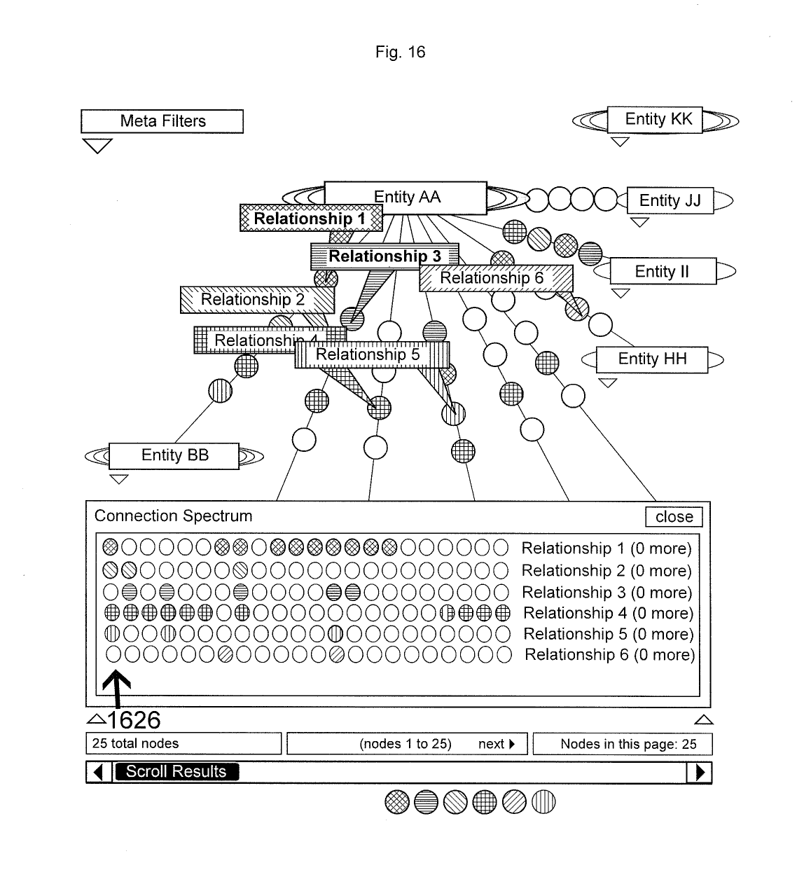

FIG. 16 illustrates how the user may lock multiple beads to see multiple relationships in the airplane view. In this view, each vertical column represents one node to which the search term is connected. Each horizontal row corresponds to one type of relationship. Each colored icon (in this case, an oval) indicates that a particular relationship connects a node to the search term. Each non-colored icon indicates that a particular relationship does not exist between a node and the search term. In FIG. 16, the user has locked the beads for relationship 1, 2, 3, 4, 5, and 6, and sees those relationships sequenced in the data in the airplane view. For instance, the first node in the necklace, “Entity BB” (vertical column 1626 of beads in FIG. 16) is connected to the search term, “Entity AA,” by relationships 1, 2, 4, and 5. The user can see that other nodes are connected to the search term by different combinations of relationships. By locking and unlocking beads, the user activates and de-activates display of different relationships in the airplane view. By providing an interactive, configurable overview of relationship combinations in large number of nodes, this mode allows the user to explore and identify different patterns of relationships in the data.

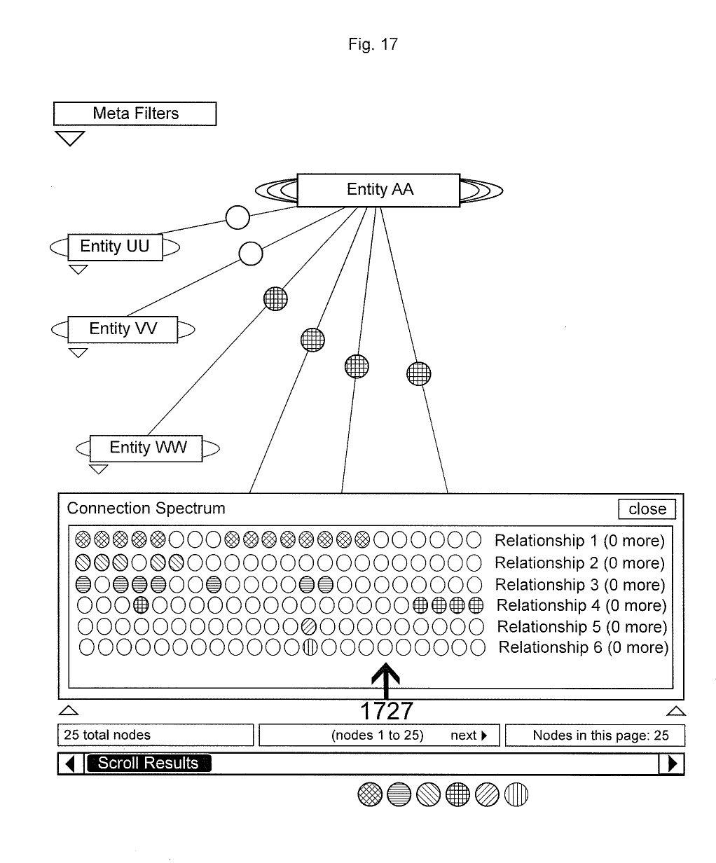

FIG. 17 illustrates how the user may navigate through search results in the airplane view by clicking on any of the icons (in this case, ovals) associated with any node. When a user selects a position in the overview, the search results in the necklace will scroll to the position corresponding to the position the user has selected in the overview. In FIG. 17, the user has clicked on one of the ovals in vertical column 1727 associated with “Entity UU” (indicated by an arrow in this figure). The necklace has automatically scrolled around clockwise and stopped at a position where “Entity UU” is the left-most node displayed on the necklace. The user now sees the last six nodes in the search results in both the airplane view (they are the six vertical columns at the right end) and on the necklace.

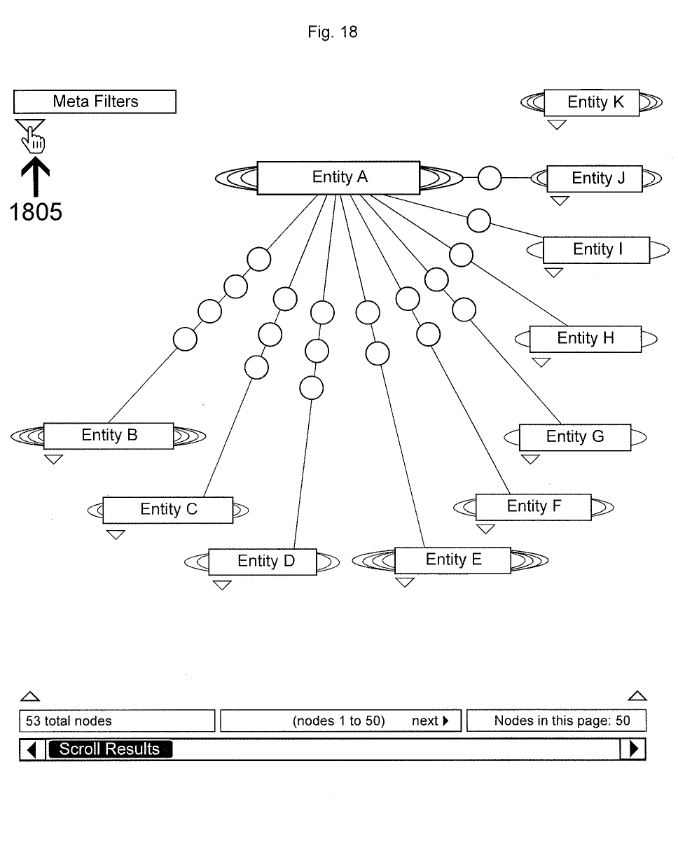

FIG. 18 illustrates how the user can access data filtering capability by activating meta filter control 1805, indicated by an arrow in FIG. 18.

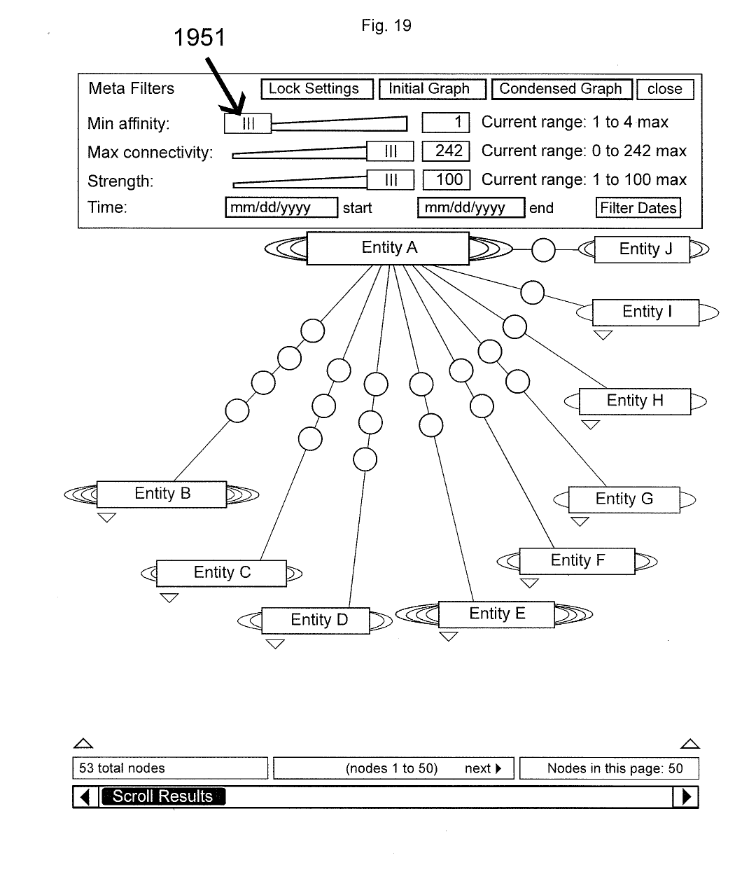

FIG. 19 illustrates how the user may filter by affinity, using the meta filter control. FIG. 19 shows a search result in which the affinity distribution is as follows:

| ← Node | Affinity (# relationships to search term) |
|---|---|
| ← Entity B | 4 |
| ← Entity C, D | 3 |
| ← Entity E, F, G | 2 |
| ← Entity H, I, J | 1 |

There is a total number of 50 nodes in the search. The ones after J are not visible in this figure, and they all have an affinity of one (nodes are ranked in order of affinity). Using a control, indicated, by an arrow in FIG. 19, the user may increase the minimum affinity necessary to display nodes in the search result. In this case, the control is slider bar 1951, and the user shifts the position of the slider from left to right. A simple form-field for numerical text would serve an equivalent function. The affinity filter control is dynamically configured for each search—the maximum possible affinity value for the filter is the affinity value of the highest-affinity node in the search (in this case, 4).

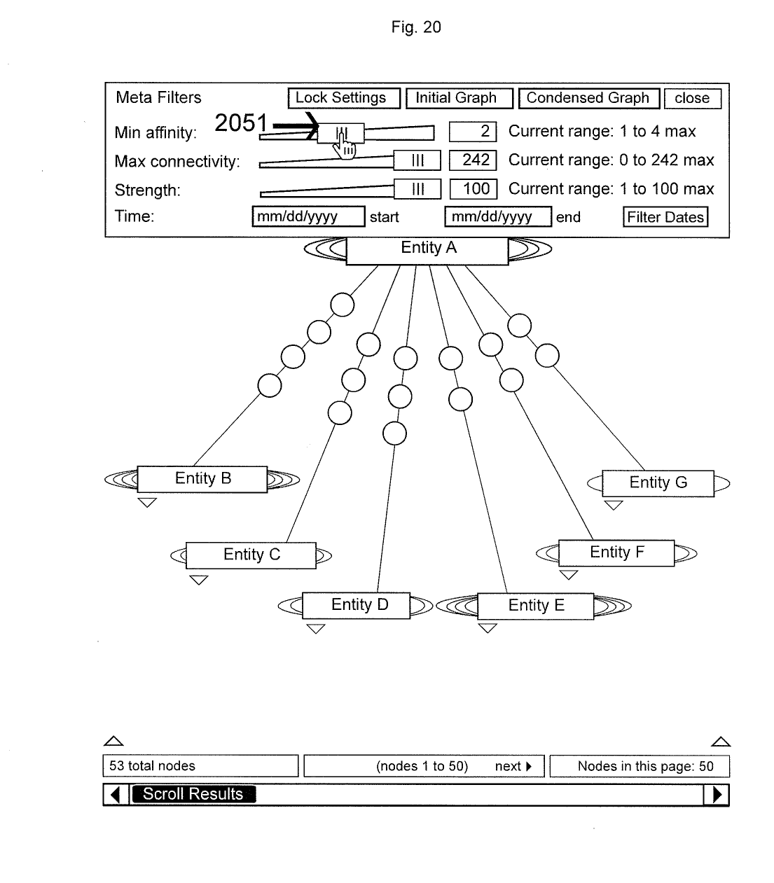

In FIG. 20, the meta filter control for affinity is set at 2, and all the nodes with only one relationship to the search term have vanished from the display. If the affinity threshold is set at greater than two, then all the nodes with only two relationships to the search node will vanish from the display, and so on. Slider bar 2051 in this figure indicates that the user has chosen to restore the meta control filter to 2.

The user may adjust his settings so that the affinity threshold is either a minimum or a maximum. In the example above, it is a minimum threshold. If the threshold is a maximum threshold, then instead of showing results that have “x or more” relationships to the search term, the display shows results that have “x or fewer.”

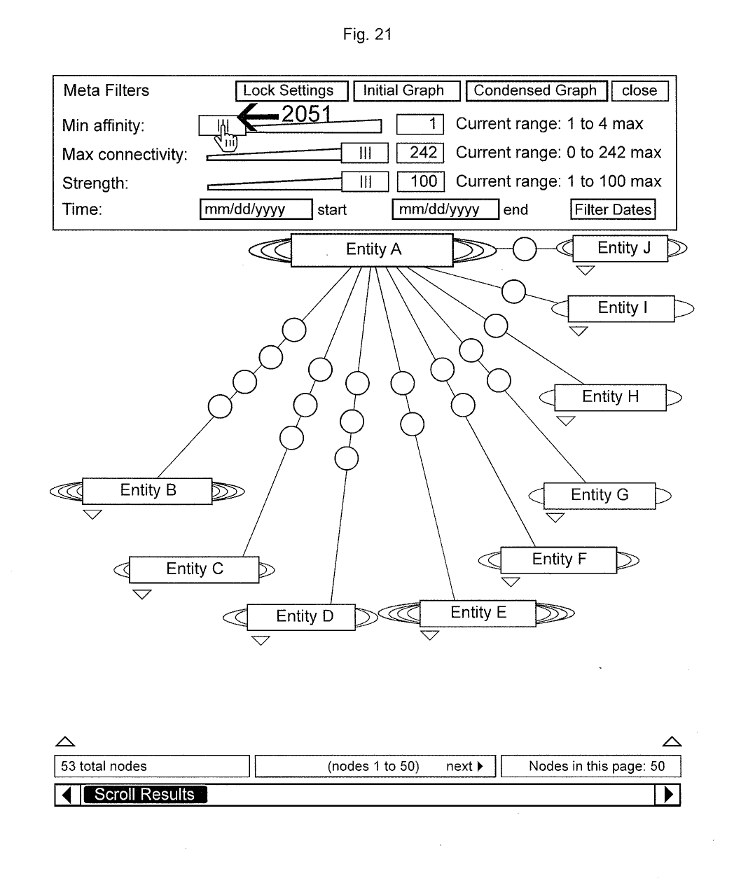

In FIG. 21, the meta filter control for affinity (slider bar 2051) has been restored to 1, and all nodes in the search result have re-appeared in the display.

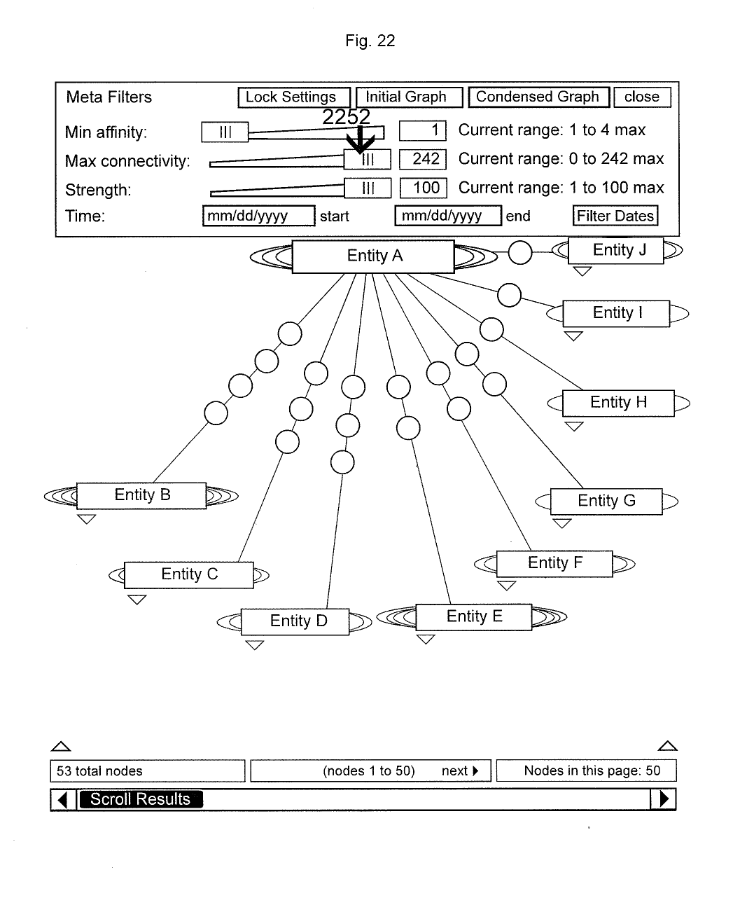

FIG. 22 illustrates how the user may also filter by connectivity, i.e. the total connection count of any given node. The connectivity filter control 2252 is dynamically configured for each search—the maximum possible affinity value for the filter is the connectivity value of the highest-connectivity node in the search (in this case, 242). Using a control, indicated by an arrow in FIG. 22, the user may decrease the maximum connectivity necessary to display nodes in the search result. In other words, if a term is connected to one or more “super-connector” nodes with a high number of relationships, the user may filter out those super-connectors. In many cases, super-connectors are a common denominator in the network graph, so displaying them doesn't convey any additional information about any particular node (i.e. the daily contact you have with the security guard in the lobby doesn't convey any information about your position in the organization). Eliminating super-connectors from the display therefore increases the signal to noise ratio of the search result. In FIG. 22, the super-connector nature of Entity B and Entity E is visually indicated by the width of the ellipses around those nodes.

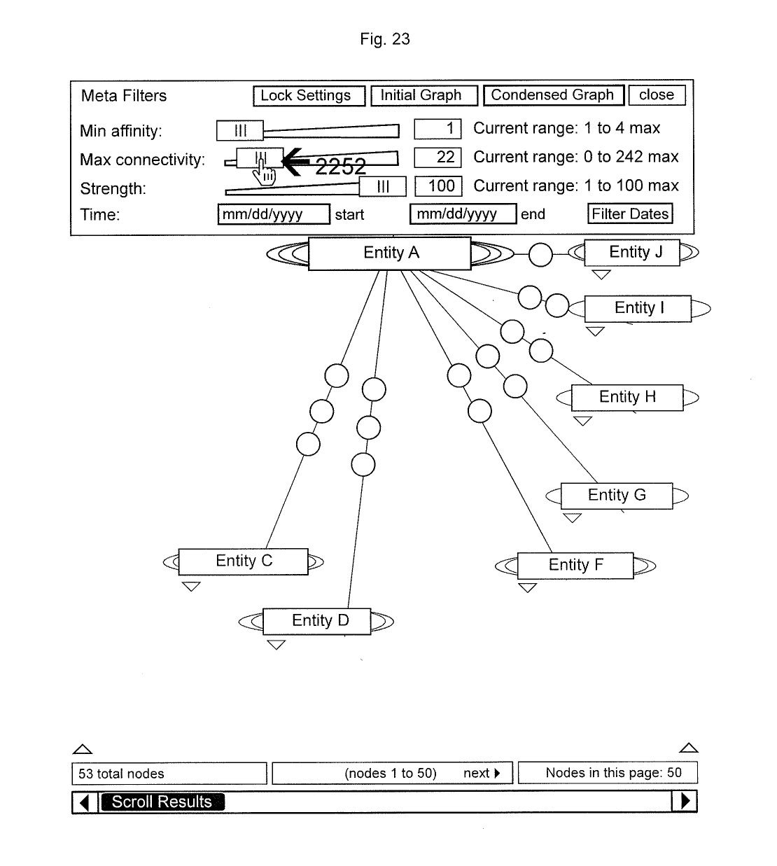

In FIG. 23, the maximum affinity threshold has been reduced from 242 to 22, using the meta filter control for connectivity 2252, indicated by an arrow. Entity B and Entity E, both super-connectors, have vanished from the display.

The user may adjust his settings so that the connectivity threshold is either a minimum or a maximum. In the example above, it is a maximum threshold. If the threshold is a minimum threshold, then instead of showing results that have “x or fewer” total connections, the display shows results that have “x or more.”

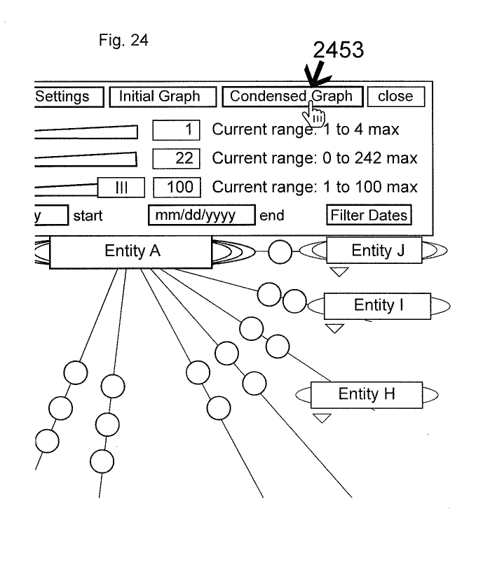

FIG. 24 illustrates how, in the process of using filter controls, the user may eliminate a significant number of nodes from the display. In order to make efficient use of the available display space, the user may wish to visually condense the search results, so that the empty space formerly occupied by filtered-out nodes can be filled by the remaining, post-filter results. The user may activate control 2453 to visually condense the results.

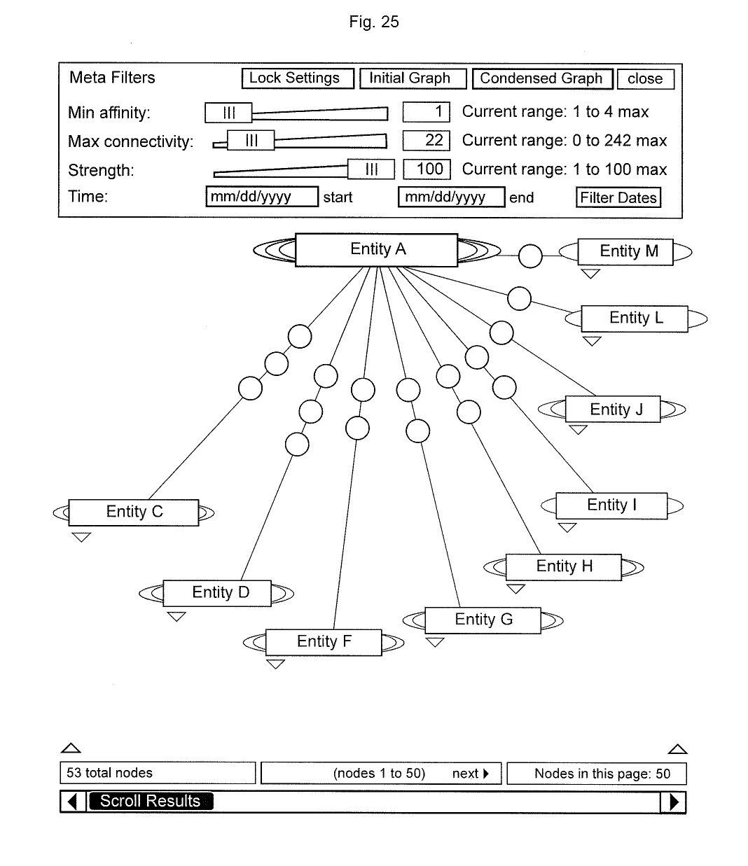

FIG. 25 illustrates the display in FIG. 24 after the results have been condensed. The user now sees “Entity L” and “Entity M” on the display. Implicit in this illustration is that Entity K is a highly connected node which was filtered out.

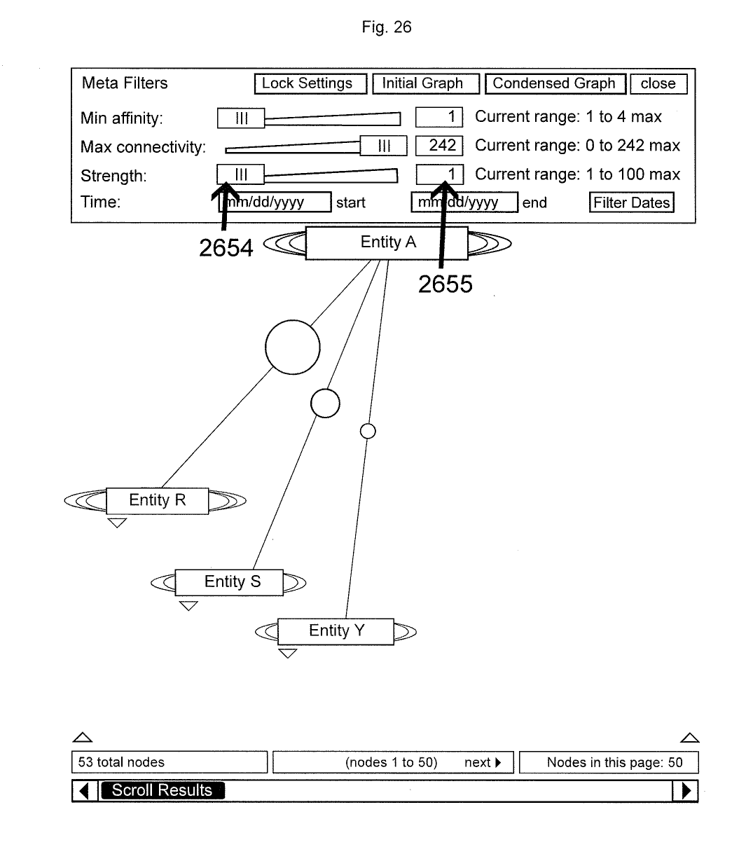

FIG. 26 illustrates how the user may activate meta filter control 2654 to filter on the strength of relationships in the data. Strength weightings for relationships, which may be imported a priori with a data set or added post-facto by the user, are visually indicated by the connection icons in the display. In this figure, the user has chosen to have the beads change size according to the strength rating of their respective relationships, but shifts in color, brightness or shape would serve an equivalent function. As with the affinity and connectivity filters, the user can eliminate nodes from the display by setting a threshold on the strength parameter.

As with affinity and connectivity filter controls user may designate the strength threshold as either a minimum or a maximum. The current strength value can be displayed in strength display 2655.

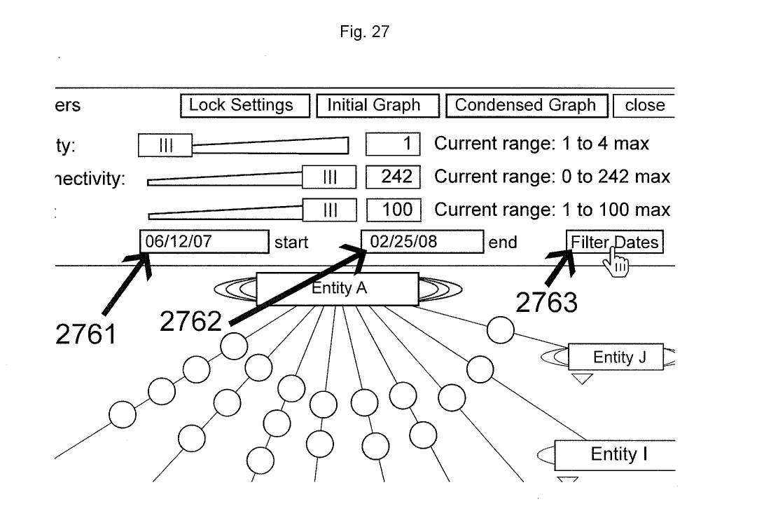

FIG. 27 illustrates how the user may activate meta filter controls to constrain the display of search results by date. The user may specify a range of dates, for example in fields 2761 and 2762 related to start and end dates, respectively, to filter nodes out of the display. The user can click on “Filter Dates” button 2763 to initiate or activate the filter.

By altering his settings, the user may designate this date range as either an inclusion constraint or an exclusion constraint. In other words “show me all of the relationships that occurred during this date range” vs. “show me all of the relationships that did not occur during this date range.”

In the business analysis scenario, an analyst might use date ranges to filter for transactions that occurred when one salesperson was responsible for a sales territory, vs. her predecessor or successor. By using both inclusive and exclusive date range filters, the analyst could see the number and type of sales for which one salesperson was responsible during her tenure, vs. the territorial sales profile for all periods not associated with her tenure.

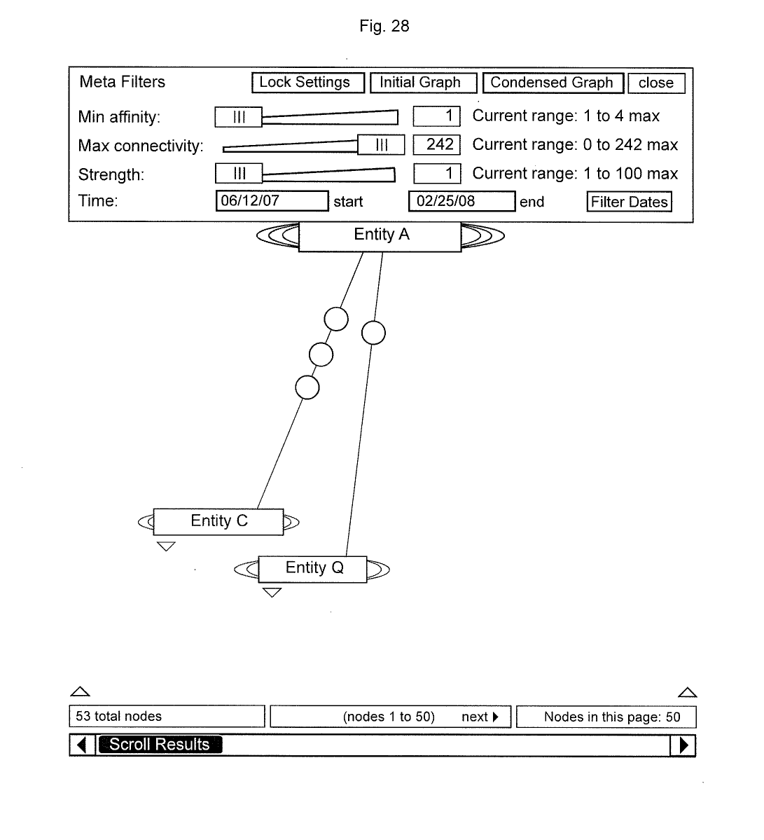

FIG. 28 shows search results filtered according to the date range values specified in FIG. 27.

The ability not only to filter by one of the meta filter control parameters, but also to combine them, enables new methods of automating analytical inquiry and the display of analytical results. For instance, combining affinity and connectivity filters allows the user to foreground patterns of affiliation which might not be obvious in the raw geometry of the network.

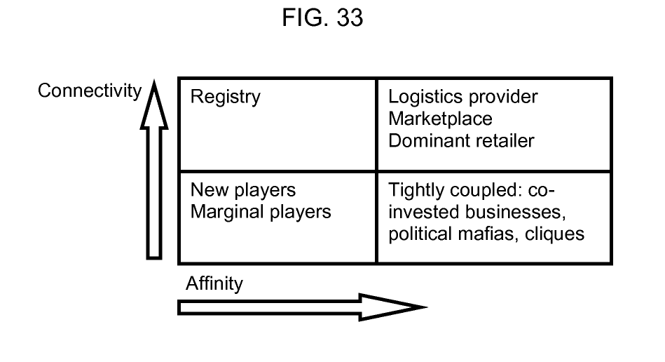

For a business analyst, shifting between different ends of the connectivity and affinity ranges allows the user to view different business profiles in the graph. Based on the combination of filters, there are four profiles that the analyst may view by shifting the range values of affinity of connectivity, as shown in FIG. 33 and below:

←High Connectivity, Low Affinity

←High Connectivity, High Affinity

←Low Connectivity, High Affinity

←Low Connectivity, Low Affinity

High connectivity, low affinity players don't have many relationships or transactions with any given entity, but they deal with everyone. An example of this profile would be the White Pages. A industry's corporate registry would also fit this profile—you register your company, get a number, and that's the only relationship you have with the registry.

High connectivity, high affinity players have a lot of relationships or transactions with a lot of other players. An example of this profile would be a commodity supplier that sells everyone something on a high-frequency basis, e.g. a big package delivery company, a central marketplace or exchange, or a dominant retailer that sells everyone's products.

Low connectivity, high affinity players are tightly coupled—they don't have a lot of relationships or transactions in total, but they have a lot of relationships or transactions with a small number of other players. A small group of companies that sold a lot of products, but only to each other, would fit this profile. For instance, there might be a small group of technology companies that make highly specialized research equipment components, which they sell to each other and to a small number of labs that use the equipment. The technology companies sell a lot of components, but to a list of partners and end-users you could count on two hands.

Low connectivity, low affinity players are either new players or marginal players—they don't have many relationships or transactions with any other player, or in the marketplace. A marginal player might be highly successful or profitable, just not highly connected in a particular marketplace. For instance, company in one industry might have a technology that it wants to sell to customers in another industry. It's not highly connected, nor does it have many relationships in its new target industry. This does not necessarily mean it's a new company, or a small company—it's just at the margin of its new target market.

By adjusting the values of the meta filter controls, the user can shift his view of the network between profiles, as entities at different ends of each spectrum vanish from the display.

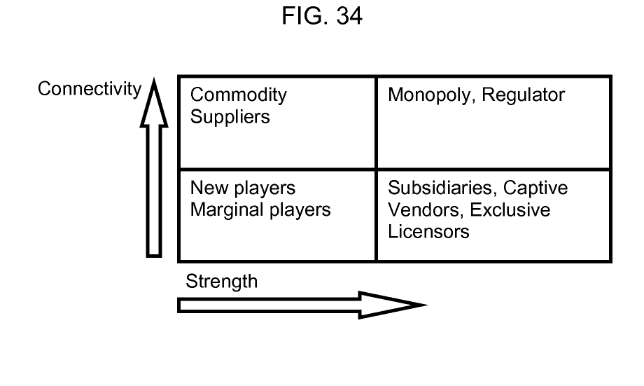

An analogous matrix of connectivity and strength (if strength correlated with the dollar value of a transaction), the matrix would break down into four profiles, as shown in FIG. 34 and below:

←High connectivity, low strength

←High connectivity, high strength

←Low connectivity, high strength

←Low connectivity, low strength

A high connectivity, low strength player has low-value relationships or transactions with everyone. Commodity suppliers of office supplies and pizza delivery companies fit this profile.

A high connectivity, high strength player has high-value relationships or transactions with everyone. A monopoly provider of necessary and expensive software would fit this profile, as would the IRS.

Low connectivity, high strength players have extremely important or high-value relationships or transactions, but only with a few other players. A corporate subsidiary that only sells to its parent company would fit this profile—it's got a lot of cash flow, but it's extremely dependent on that one customer.

Low connectivity, low strength players are small or emergent entities that don't have many relationships or transactions, and whose relationships and transactions are low-value. New, small start-up companies would fit this profile.

By adjusting the values of the meta filter controls, the user can shift his view of the network between profiles, as entities at different ends of each spectrum vanish from the display.

Text-based metadata filters may be used alter the display based on automatically generated or user-generated metadata associated with triples, such as source (triples from a specified source list are eliminated from the display), the collection of data to which triples belong (triples from specified collections are eliminated from the display), contributor (triples contributed by specified users are eliminated from the display), or tags (triples labeled with a specific term are eliminated from the display).

Current technologies for analysis and display of networked relationships draw a sharp distinction between nodes (entities in the database) and links (the relationships that connect those entities). Nodes and links are treated as fundamentally different phenomena, both as data objects and as concepts embodied in graphical displays. This distinction is typified by the expression “connect the dots.” We believe this hard distinction is fundamentally simplistic, and drastically limits the sophistication of analysis that can be performed using tools where there are dots and links and ne'er the twain meet.

In the human mind, the distinction between entities and connections is quite fluid. One might think of the friendship between Alice and Bob, and between Bob and Carl, and think “Alice and Carl are both friends of Bob.” In this case, Alice, Bob, and Carl are entities and friendship is the connecting relationship that links both Alice and Carl to Bob. But one might just as easily perceive the relationship as “Alice and Carl know each other through Bob.” In this formulation, Alice and Carl are first class entities, and Bob is a mediating relationship. Mentally, people oscillate between concepts of nodes and links in their analysis of social and professional networks, and the fuzziness of that distinction allows them to analyze networks faster, and in more sophisticated ways, than would be possible with a conventional network graphing tool which only displays the raw geometry of the network. By allowing users to transform nodes into links, and links into nodes, the disclosed techniques allow for fundamentally different and more powerful analytical processes than are enabled by current network-graphing technologies.

One method of shifting the status of links and nodes is to specify a particular combination of relationships, and treat that combination of relationships as a first-class object or an entity. For instance, a sales analyst might decide that purchasing a particular combination of products (A, B, C, and D) defines a market segment for “Company X,” which sells those products. The analyst runs a search, prioritizes the graph (using the controls illustrated in FIG. 12), and sees that 8 companies have purchased the combination of products A, B, C, and D from “Company X” (each product appears as a relationship bead between “Company X” and each customer, as in FIG. 10. By activating a control (not illustrated) in the Prioritize Graph field, the user may save and name the combination of relationships A, B, C, and D to “Company X” as a profile.

Multi-relationship profiles persist from session to session. A user can run a search using a stored profile, and see what entities match against that profile, including those whose information was added after the original profile was saved.

The system can also notify a user when new data results in an additional match of one or more entities to a saved profile.

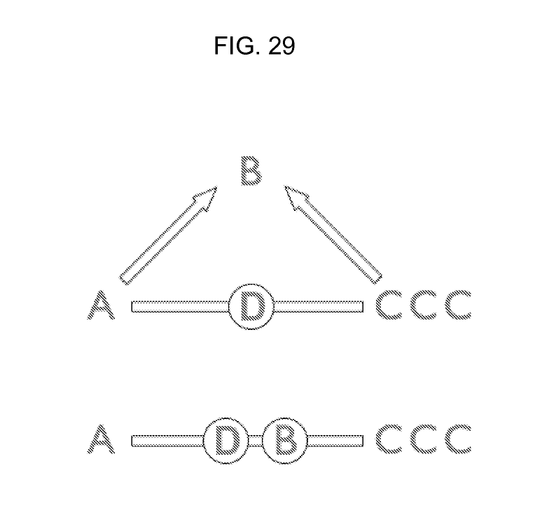

FIG. 29 is an abstract diagram of the process whereby a node in the data, i.e. a term at either end of a triple, is transformed into a connecting term. In the diagram, “Entity A,” “Entity B,” and “Entity CCC” embody three entities with three relationships:

←Entity A˜[unlabeled relationship]˜Entity B

←Entity B˜[unlabeled relationship]˜Entity CCC

←Entity A˜[relationship D]˜Entity CCC

In the top-most image in FIG. 29, these three entities are displayed as three two-degree relationships, which renders their geometry in a network graph, i.e. three nodes connected by three edges. The three two-degree relationships are:

Entity A˜[unlabeled relationship]˜Entity B˜[unlabeled relationship]˜Entity CCC
Entity A˜[relationship D]˜Entity CCC˜[unlabeled relationship]˜Entity B
Entity B˜[unlabeled relationship]˜Entity A˜[relationship D]˜Entity CCC

Using the disclosed system, one is able to designate an intermediary node, in this case “Entity B” as a connection, and see the graph re-factored as if this node were simply a link between entities that have a first-degree relationship to “Entity B.” In mathematical terms, the user is taking the derivative of a relationship, by reducing its degree from two to one. We refer to this operation as “collapsing a node.”

When a user collapses a nodes, the visualization component of the application generates a query for all direct relationships between the original search term and the nodes connected to the pivot term, i.e. second-degree relationships to the search term, through the pivot term. We refer to the nodes in these second degree relationships as “second degree nodes.” All triples containing the search term and a second degree node are returned as a query result, and are added to the display as first degree connections between the search term and the second-degree nodes, which have been transformed into first degree connections through the collapsed node.

The bottom image in FIG. 29 represents the resulting transformation, which displays a first-degree compound relationship between Entity A and Entity CCC, through Relationship D and the collapsed “Entity B” node, which is now treated as a relationship for the purposes of filtering and display. The Entity A—Entity CCC link has an affinity of two, and is treated as if it consisted of two relationships:

←Entity A˜[relationship B]˜Entity CCC

←Entity˜[relationship D]˜Entity CCC

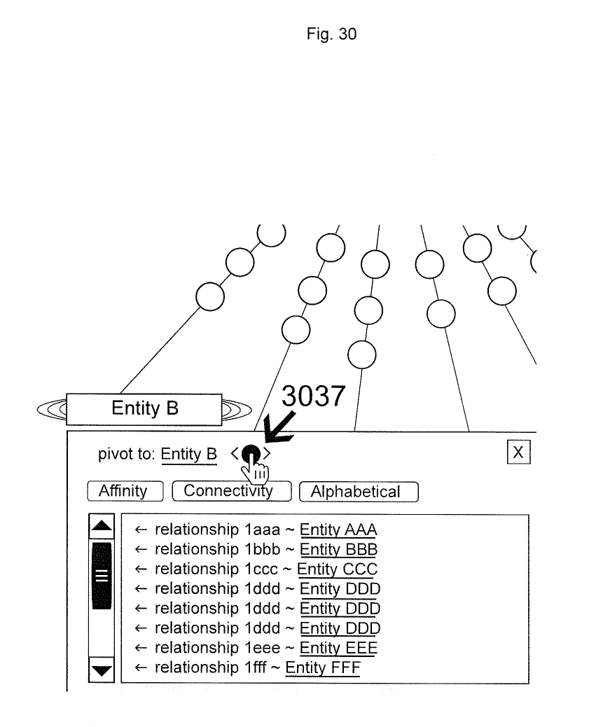

FIG. 30 illustrates how the user may collapse nodes by activating control 3037 proximate to the node in a data presentation display. In this figure, we also see “Entity B”s relationships listed in the peek-ahead list. In a business context, this might be a list of the customer's transaction partners (the customer's customers, partners and suppliers).

In the peek-ahead list in FIG. 30, we see that “Entity B” has three different relationships to “Entity DDD”:

←Entity B˜relationship 1ddd˜Entity DDD

←Entity B˜relationship 2ddd˜Entity DDD

←Entity B˜relationship 3ddd˜Entity DDD

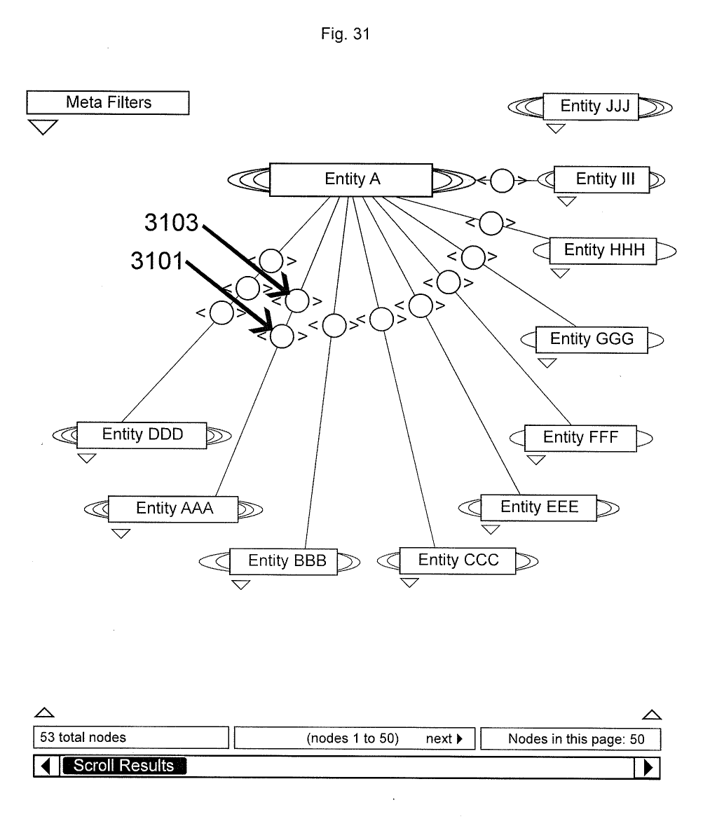

FIG. 31 illustrates the search result transformed by the collapse-node operation in FIG. 30. The original search term, “Entity A,” now has an “Entity B” relationship to all the nodes that have a direct relationship to “Entity B.” The “Entity B” relationship is the product of the collapsed “Entity B” node, and is visually differentiated from normal relationship beads in the display. For example, relationship 3101 is a relationship that is a product of a collapsed node, and relationship 3103 is a direct relationship between “Entity A” and Entity AAA.” In this display, “Entity DDD” has the highest affinity to “Entity A,” because it has three relationships through collapsed “Entity B” nodes. These three collapsed “Entity B” relationships correspond to “Entity B”'s three relationships with “Entity DDD.”

In FIG. 31, we also see relationship 3103, a second, direct relationship between “Entity A” and “Entity AAA.” This direct, first-degree relationship between “Entity A” and “Entity AAA” was present in the data prior to collapsing the “Entity B” node. “Entity AAA” was not displayed in preceding figures because it only had one relationship to “Entity A,” and therefore was behind the other, higher-affinity nodes in the sequence of display. In FIG. 31, “Entity AAA” has an affinity of two—a direct relationship to “Entity A” as well as a relationship through the collapsed “Entity B” node—so it is displayed second (after “Entity DDD”) in the affinity-ranked sequence of results.

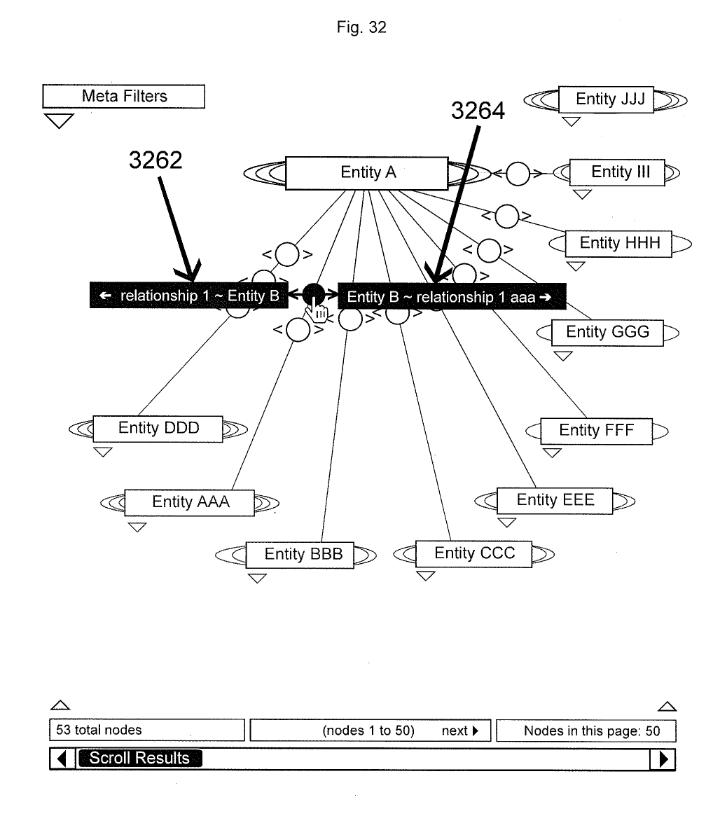

FIG. 32 illustrates the display of a two-box text label (including text box 3262 and text box 3264) describing the collapsed “Entity B” relationship between “Entity A” and “Entity AAA.” Unlike a regular relationship bead, a collapsed relationship bead is labeled with a compound description indicating the relationships on either side of the collapsed node. In this example, the linking relationships between “Entity B,” “Entity A,” and “Entity AAA” are:

←Entity B˜relationship 1˜Entity AAA

←Entity B˜relationship 1aaa˜Entity AAA

So the text description of the collapsed “Entity B” relationship between “Entity A” and “Entity AAA” is comprised of two text boxes: “relationship 1˜Entity B” and “Entity B˜relationship 1aaa” as illustrated in FIG. 32.

Some embodiments described herein relate to a computer storage product with a computer-readable medium (also can be referred to as a processor-readable medium) having instructions or computer code thereon for performing various computer-implemented operations. The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), and Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

### CONCLUSION

In conclusion a system and method for data analysis and presentation has been described. Those skilled in the art can readily recognize that numerous variations and substitutions can be made to the disclosed embodiments. Their use and configuration to achieve substantially the same results as achieved by the embodiments described herein. Accordingly, there is no intention to limit the scope of protection to the disclosed exemplary forms. Many variations, modifications, and alternative constructions fall within the scope and spirit of the protection as expressed in the claims. For example, the icons may have visual characteristics not illustrated in the Figures such as different shapes, line weights, or other visual differentiations can be included in the icons. Furthermore, the disclosed techniques are applicable to wide range of industries and endeavors. In addition, although references are made to particular embodiments, all embodiments disclosed herein need not be separate embodiments. In other words, features disclosed herein can be utilized in combinations not expressly illustrated.

In one embodiment, a method includes presenting and navigating data displayed using multiple icons. The icons are displayed on an axis between two entities to indicate that the entities have multiple relationships, with the names of the relationships displayed either temporarily or persistently. The user is able to select and de-select one or more relationships to visually highlight or differentiate specific combinations of relationships between entities throughout the search results.

In some embodiments, the method includes displaying multiple icons representing multiple relationships between two entities. These icons are displayed in a sequence according to the frequency distribution of relationships in the whole data set, or a subset thereof, to which the user has access.

In some embodiments, the method includes results of a search for relationships between a search term and other entities. These results are displayed in sequence according to the number of relationships between connected nodes and the search term. Multiple icons between the search term and a particular node represent the connections between those nodes and the search term.

In some embodiments, the method includes the user selecting specific combinations of relationships. The relationships are reconfigured to prioritize the display of entities with the specified combination of relationships between them.

In some embodiments, the method includes naming and saving specific combinations of relationships in a network of relationships. These combinations can be displayed and filtered as if each is a subject-node or entity within the data set.

In some embodiments, the method includes displaying data about relationships in a summary format. From the summary view, the user may select and de-select specific combinations of relationships and see an overview of the occurrence of those combinations of relationships in a sequenced search result.

In some embodiments, the method includes the user navigating data about relationships by selecting a position among one or more relationships in a sequenced summary view. Selecting a position enables the user to view a larger and more detailed display of networked relationships

In some embodiments, the method includes filtering data about relationships according to the numerical distribution of relationships between entities. The user may eliminate nodes from a display based on the number of relationships between those nodes and a designated entity.

In some embodiments, the method includes filtering data about relationships according to the numerical distribution of relationships between entities. The user may eliminate nodes from a display based on the total number of relationships to those nodes (i.e. the connectivity of the nodes).

In another embodiment, a method includes combining filters on parameters in the metadata associated with an entity and its relationships. The parameters filtered include, but are not limited to, the total number of relationships to other entities (i.e. connectivity), total number of relationships between any two given (i.e. affinity), date of the relationship, and a scalar weighting representing the strength of the relationship or a confidence rating on the information.

In some embodiments, the method includes connectivity and affinity filters combined to shift a display between profiles defined by the combination of connectivity and affinity.

In some embodiments, the method includes connectivity and strength or confidence filters combined to shift a display between profiles defined by the combination of connectivity and strength or confidence.

In some embodiments, the method includes adjusting threshold values for connectivity, affinity, and strength or confidence between minimum and maximum values.

In some embodiments, the method includes adjusting a date range between inclusive and exclusive ranges.

In another embodiment, a method includes manipulating an entity to visually transform a node into a relationship and treating the node as a link for the purpose of filtering and display.

What is claimed is:

1. A method, comprising:
accessing a first data set including a first identifier associated with a first entity, a second identifier associated with a second entity, and a first relationship;
accessing a second data set including the first identifier, the second identifier, and a second relationship; and
displaying a visual representation of the first identifier, a visual representation of the second identifier, a visual representation of the first relationship, and a visual representation of the second relationship, the visual representation of the first relationship and the visual representation of the second relationship displayed on a path, the path connecting the visual representation of the first identifier and the visual representation of the second identifier.

2. The method of claim 1, wherein:
the visual representation of the first identifier is a first icon based on a number of relationships associated with the first entity; and
the visual representation of the second identifier is a second icon based on a number of relationships associated with the second entity, the second icon different from the first icon.

3. The method of claim 1, wherein the path is a first path and the visual representation of the first relationship is a first visual representation of the first relationship, the method further comprising:
accessing a third data set including the first identifier, a third identifier associated with a third entity, and the first relationship; and
displaying a visual representation of the third identifier and a second visual representation of the first relationship, the second visual representation of the first relationship displayed on a second path, the second path connecting the visual representation of the first identifier and the visual representation of the third identifier.

4. The method of claim 1, wherein the path is a first path and the visual representation of the first relationship is a first visual representation of the first relationship, the method further comprising:
accessing a third data set including the first identifier, a third identifier associated with a third entity, and the first relationship;
displaying a visual representation of the third identifier and a second visual representation of the first relationship, the second visual representation of the first relationship displayed on a second path, the second path connecting the visual representation of the first identifier and the visual representation of the third identifier; and
altering the first visual representation of the first relationship and the second visual representation of the second relationship in response to input from a user associated with a selection of the first visual representation.

5. The method of claim 1, further comprising displaying a textual description of the first relationship in response to input from a user.

6. The method of claim 1, wherein the visual representation of the first relationship and the visual representation of the second relationship are displayed on the path in a sequence based on a frequency distribution of the first relationship within a data superset and a frequency distribution of the second relationship within the data superset, the data super set including the first data set, the second data set and other data sets that include at least one of the first relationship or second relationship.

7. The method of claim 1, wherein the accessing the first data set and the accessing the second data set are in response to a search term provided by a user and including a portion of the first identifier.

8. The method of claim 1, wherein the path is a first path and the visual representation of the first relationship is a first visual representation of the first relationship, the method further comprising:
accessing a third data set including the first identifier, a third identifier associated with a third entity, and the first relationship;
displaying a visual representation of the third identifier and a second visual representation of the first relationship, the second visual representation of the first relationship displayed on a second path, the second path connection the visual representation of the first identifier and the visual representation of the third identifier; and
removing the visual representation of the third identifier and the second visual representation of the first relationship in response to input from a user associated with filtering based on the second relationship.

9. The method of claim 1, wherein the path is a first path and the visual representation of the first relationship is a first visual representation of the first relationship, the method further comprising:
accessing a third data set including the first identifier, a third identifier associated with a third entity, and the first relationship;
displaying a visual representation of the third identifier and a second visual representation of the first relationship, the second visual representation of the first relationship displayed on a second path, the second path connection the visual representation of the first identifier and the visual representation of the third identifier; and
removing the visual representation of the third identifier and the second visual representation of the first relationship in response to input from a user associated with filtering based on a number of relationships between the first identifier and the third identifier.

10. The method of claim 1, further comprising:
accessing a third data set including the second identifier, a third identifier associated with a third entity, and a third relationship; and
displaying a textual description of the third identifier and the third relationship, the accessing a third data set and the displaying the textual description of the third identifier and the third relationship in response to input from a user, the input associated with a selection of the visual representation of the second identifier.

11. The method of claim 1, further comprising:
accessing a third data set including the second identifier, a third identifier associated with a third entity, and a third relationship between the second identifier and the third identifier;
defining a new relationship between the first entity and the third entity based on the second identifier; and
displaying a visual representation of the third identifier and a visual representation of the new relationship, the visual representation of the new relationship displayed on a second path, the second path connecting the visual representation of the first identifier and the visual representation of the third identifier.

12. A method, comprising:
providing a graphical representation of a data set at a display device,
the data set including relationships between a plurality of entities, each entity from the plurality of entities related with another entity from the plurality of entities by one or more relationships,
the graphical representation including a plurality of icons representing the plurality of related entities and a plurality of icons representing the one or more relationships relating any two entities from the plurality of entities located on an axis between those two entities from the plurality of entities;
receiving filtering input from a user; and
updating the graphical representation based on the filtering input.

13. The method of claim 12, wherein:
the filtering input includes a minimum number of relationships; and
the updating includes removing from the graphical representation any entity from the plurality of entities having fewer than the minimum number of relationships with another single entity from the plurality of entities.

14. The method of claim 12, wherein:
the filtering input includes a minimum number of relationships; and
the updating includes removing from the graphical representation any entity from the plurality of entities having fewer than the minimum number of relationships with the remaining entities from the plurality of entities.

15. The method of claim 12, wherein:
the data set includes metadata associated with at least a portion of the entities from the plurality of entities; and
the filtering input includes a parameter associated with the metadata.

16. The method of claim 12, wherein:
the filtering input includes a selection of a type of relationship; and
the updating includes re-sequencing a portion of icons from the plurality of icons such that icons from the plurality of icons representing entities from the plurality of entities related to other entities from the plurality of entities by the type of relationship are displayed first in the graphical representation, and
the updating includes identifying each relationship of the type of relationship with a color different from a color with which the remaining relationships are identified.

17. A processor-readable storage medium storing code representing instructions to be executed by a processor, the code comprising code to:
provide a graphical representation of a data set at a display device,
the data set including relationships between a plurality of entities, each entity from the plurality of entities related with another entity from the plurality of entities by one or more relationships,
the graphical representation including a plurality of icons representing the plurality of related entities and icons representing the one or more relationships relating any two entities from the plurality of entities located on an axis between those two entities from the plurality of entities;
detect a selection of a portion of the graphical representation by a user via an input device; and
update the graphical representation based on the selection.

18. The processor-readable medium of claim 17, further comprising code to:
receive a combination of relationships; and
defining a new entity based on the combination of relationships such that entities from the plurality of entities related with another entity from the plurality of entities by the relationships included in the combination of relationships are related to the new entity.

19. The processor-readable medium of claim 17, wherein:
the selection is a selection of a relationship in the graphical representation;
the code comprising code to update the graphical representation is operable to remove from the graphical representation entities from the plurality of entities that are not related with another entity from the plurality of entities by the selected relationship; and
the graphical representation includes a matrix of icons, each icon from the matrix of icons representing a relationship associated with an entity from the plurality of entities, each column of the matrix of icons associated with an entity from the plurality of entities such that the each icon from the matrix of icons in that column represents a relationship of that entity from the plurality of entities, each row of the matrix of icons associated with a particular type of relationship.

20. The processor-readable medium of claim 17, further comprising code to define a new relationship between a first entity from the plurality of entities and a second entity from the plurality of entities, each of the first entity and the second entity from the plurality of entities being related to a third entity from the plurality of entities, the new relationship based on the relationships of the first entity and the third entity to the second entity from the plurality of entities.
